(19) United States
(12) Patent Application Publication
(10) Pub. No.: US 2023/0288712 A1
(43) Pub. Date: Sep. 14, 2023

(54) Head-Mounted Device With Impact Mitigation

(71) Applicant: APPLE INC., Cupertino, CA (US)

(72) Inventors: Adam Y. Kollgaard, Santa Cruz, CA (US); Jeremy C. Franklin, San Francisco, CA (US); Scott M. Leinweber, Sunnyvale, CA (US); Venkata Narayana Murthy Arelekatti, Palo Alto, CA (US); Paul X. Wang, Cupertino, CA (US); John Cagle, San Jose, CA (US)

(73) Assignee: APPLE INC., Cupertino, CA (US)

(21) Appl. No.: 18/125,557

(22) Filed: Mar. 23, 2023

Related U.S. Application Data
(63) Continuation of application No. PCT/US2021/051627, filed on Sep. 23, 2021.
(60) Provisional application No. 63/082,645, filed on Sep. 24, 2020.

(51) Int. Cl. G02B 27/01; G06F 1/16

(52) U.S. Cl. CPC G02B 27/0176; G06F 1/163; G06F 1/1656

(57) ABSTRACT

A device includes a device housing, a facial interface, a support structure, content display components, and an impact mitigation structure that is configured to mitigate an impact with an external structure.

### CROSS-REFERENCE TO RELATED APPLICATIONS

This application is a continuation of PCT Application No. US2021/051627, filed on Sep. 23, 2021, which claims the benefit of U.S. Provisional Application No. 63/082,645, filed on Sep. 24, 2021, the contents of which are hereby incorporated herein in their entireties for all purposes.

### FIELD

The present disclosure relates generally to the field of head-mounted devices.

### BACKGROUND

Computer-generated reality content can be experienced using handheld devices or using wearable devices. Computer-generated reality devices that are worn by a user typically include a near-eye display that shows computer-generated content to the user. The near-eye display is conventionally located in a housing that is supported by the user's head, for example, using a headband.

### SUMMARY

A first aspect of the disclosure is a head-mounted device that is configured to be worn by a user. The head-mounted device includes a device housing, a facial interface that is connected to the device housing, a support structure that is configured to support the device housing with respect to the user so that the facial interface is in contact with a face of the user, content display components that are located in the device housing and are configured to display content to the user, and an impact mitigation structure that is configured to mitigate an impact with an external structure.

In some implementations of the head-mounted device according to the first aspect of the disclosure, the impact mitigation structure includes a bump stop that is located inside the facial interface to disperse pressure from the impact. In some implementations of the head-mounted device according to the first aspect of the disclosure, the impact mitigation structure includes springs that are located inside the facial interface and extend between an internal support structure of the facial interface and the device housing to absorb energy during the impact. In some implementations of the head-mounted device according to the first aspect of the disclosure, the impact mitigation structure includes an air filled damper that is located inside the facial interface and extends between an internal support structure of the facial interface and the device housing to absorb energy during the impact.

In some implementations of the head-mounted device according to the first aspect of the disclosure, the impact mitigation structure includes a non-Newtonian foam structure that is located inside the facial interface to absorb energy during the impact. In some implementations of the head-mounted device according to the first aspect of the disclosure, the impact mitigation structure includes an inflatable air bladder that is located inside the facial interface to absorb energy during the impact. In some implementations of the head-mounted device according to the first aspect of the disclosure, the impact mitigation structure includes deployable supports that deploy during the impact to move the device housing away from an internal support structure of the facial interface.

In some implementations of the head-mounted device according to the first aspect of the disclosure, the content display components include an optical module, and the impact mitigation structure includes an energy absorbing material that is located on a portion of the device housing that surrounds an exposed portion of the optical module to absorb energy during the impact. In some implementations of the head-mounted device according to the first aspect of the disclosure, the content display components include an optical module, and the impact mitigation structure includes a flexible portion of the device housing that is connected to the optical module and allows motion of the optical module with respect to surrounding portions of the device housing to absorb energy during the impact.

In some implementations of the head-mounted device according to the first aspect of the disclosure, the content display components include an optical module, and the impact mitigation structure includes an energy absorbing mounting structure that supports the optical module with respect to the device housing to absorb energy during the impact. In some implementations of the head-mounted device according to the first aspect of the disclosure, the content display components include an optical module, the impact mitigation structure includes a breakaway mounting structure that connects the optical module to the device housing, and the breakaway mounting structure breaks during the impact to allow movement of the optical module with respect to the device housing. In some implementations of the head-mounted device according to the first aspect of the disclosure, the impact mitigation structure includes a flexible rim that is located inside the facial interface, is stiffer than that the facial interface, and is connected to the device housing to absorb energy during the impact.

In some implementations of the head-mounted device according to the first aspect of the disclosure, the content display components include an optical module, and the impact mitigation structure includes a flexible rim that extends around an exposed portion of the optical module to absorb energy during the impact. In some implementations of the head-mounted device according to the first aspect of the disclosure, the impact mitigation structure includes dampers that are located in the support structure to regulate motion of the device housing relative to the face of the user during the impact. In some implementations of the head-mounted device according to the first aspect of the disclosure, the impact mitigation structure includes a resilient energy absorbing member that is located in the facial interface and is configured to absorb energy during the impact.

In some implementations of the head-mounted device according to the first aspect of the disclosure, the content display components include an optical module, and the impact mitigation structure includes an energy absorbing ring that is connected to an exposed portion of the optical module. In some implementations of the head-mounted device according to the first aspect of the disclosure, the impact mitigation structure includes a mounting structure that connects the facial interface to the device housing and causes the facial interface to detach from the device housing during the impact. In some implementations of the head-mounted device according to the first aspect of the disclosure, the impact mitigation structure includes a mounting structure that connects the facial interface to the device housing and allows the facial interface to slide laterally with respect to the device housing during the impact.

In some implementations of the head-mounted device according to the first aspect of the disclosure, the content display components include an optical module, and the impact mitigation structure includes a mounting structure that connects the optical module to the device housing so that the optical module is configured to pivot with respect to the device housing around a generally upright axis during the impact. In some implementations of the head-mounted device according to the first aspect of the disclosure, the content display components include an optical module, and the impact mitigation structure includes a mounting structure that connects the optical module to the device housing so that the optical module slides outward with respect to the user during the impact.

A second aspect of the disclosure is a head-mounted device that is configured to be worn by a user. The head-mounted device includes a device housing that defines an eye chamber, control electronics that are configured to generate computer-generated reality content, and optical modules that are located partly in the eye chamber and are configured to display the computer-generated reality content to the user as part of a computer-generated reality experience. The head-mounted device also includes a support structure that is configured to support the device housing with respect to the user, a facial interface that is located adjacent to the eye chamber and is configured to contact a face of the user, includes a cover, and defines and internal space that is located inside the cover, and an energy absorbing structure. The energy absorbing structure is located in the internal space of the facial interface. The energy absorbing structure is configured to control motion of the device housing during a dynamic loading event.

In some implementations of the head-mounted device according to the second aspect of the disclosure, the facial interface includes an internal support structure that is located inside the cover to define a shape of the facial interface. In some implementations of the head-mounted device according to the second aspect of the disclosure, the energy absorbing structure is connected to the device housing and extends into the internal space of the facial interface to limit movement of the internal support structure of the facial interface with respect to the device housing by engagement of the energy absorbing structure with the internal support structure of the facial interface. In some implementations of the head-mounted device according to the second aspect of the disclosure, the energy absorbing structure includes a bump stop. In some implementations of the head-mounted device according to the second aspect of the disclosure, the energy absorbing structure includes a spring. In some implementations of the head-mounted device according to the second aspect of the disclosure, the energy absorbing structure includes a resiliently compressible energy absorbing material. In some implementations of the head-mounted device according to the second aspect of the disclosure, the energy absorbing structure includes an inflatable air bladder that is located in the internal space of the facial interface and is inflated in response to the dynamic loading event.

A third aspect of the disclosure is a head-mounted device that is configured to be worn by a user. The head-mounted device includes a device housing that defines an eye chamber, control electronics that are configured to generate computer-generated reality content, and optical modules that are located partly in the eye chamber and are configured to display the computer-generated reality content to the user as part of a computer-generated reality experience. The head-mounted device also includes a support structure that is configured to support the device housing with respect to the user, a facial interface is configured to contact a face of the user, and an energy absorbing structure. The energy absorbing structure is located in the eye chamber of the device housing and is configured to control motion of the device housing during a dynamic loading event.

In some implementations of the head-mounted device according to the third aspect of the disclosure, the energy absorbing structure includes an energy absorbing material that is located on a rear wall of the eye chamber adjacent to the optical modules. In some implementations of the head-mounted device according to the third aspect of the disclosure, the energy absorbing structure includes an inflatable air bladder that is located in the eye chamber adjacent to the optical modules and is inflated in response to the dynamic loading event. In some implementations of the head-mounted device according to the third aspect of the disclosure, the energy absorbing structure includes energy absorbing rings that are each connected to one of the optical modules.

A fourth aspect of the disclosure is a head-mounted device that is configured to be worn by a user. The head-mounted device includes a device housing that defines an eye chamber, control electronics that are configured to generate computer-generated reality content, and optical modules that are located partly in the eye chamber and are configured to display the computer-generated reality content to the user as part of a computer-generated reality experience. The head-mounted device also includes a support structure that is configured to support the device housing with respect to the user, a facial interface is configured to contact a face of the user, and an impact mitigation structure that allows motion of the optical modules with respect to the device housing during a dynamic loading event.

In some implementations of the head-mounted device according to the fourth aspect of the disclosure, the impact mitigation structure is a crushable energy absorbing mounting structure that supports the optical modules with respect to the device housing. In some implementations of the head-mounted device according to the fourth aspect of the disclosure, the impact mitigation structure is a breakaway mounting structure that connects the optical modules to the device housing. In some implementations of the head-mounted device according to the fourth aspect of the disclosure, the impact mitigation structure is a mounting structure that connects the optical modules to the device housing so that the optical modules are able to pivot with respect to the device housing around a generally upright axis during the dynamic loading event. In some implementations of the head-mounted device according to the fourth aspect of the disclosure, the impact mitigation structure is a mounting structure that connects the optical modules to the device housing so that the optical modules are able to slide outward with respect to the user during the dynamic loading event.

### BRIEF DESCRIPTION OF THE DRAWINGS

FIG. 1 is a top view illustration of a head-mounted device according to a first implementation.

FIG. 2 is a block diagram that shows content display components of the head-mounted device of FIG. 1.

FIG. 3 is a top view illustration of a head-mounted device according to a second implementation.

FIG. 4 is a rear view illustration of the head-mounted device of FIG. 3 taken along line A-A of FIG. 3.

FIG. 5 is a cross-section illustration of the head-mounted device of FIG. 3 taken along line B-B of FIG. 4.

FIG. 6 is a cross-section detail illustration of a facial interface of the head-mounted device of FIG. 3 taken long line B-B of FIG. 4.

FIG. 7 is a top cross-section detail illustration of the facial interface taken along line C-C of FIG. 6.

FIG. 8 is a top cross-section illustration of an impact mitigation structure according to a first example.

FIG. 9 is a top cross-section illustration of an impact mitigation structure according to a second example.

FIG. 10 is a top cross-section illustration of an impact mitigation structure according to a third example.

FIG. 11 is a top cross-section illustration of an impact mitigation structure according to a fourth example.

FIG. 12 is a top cross-section illustration of an impact mitigation structure according to a fifth example.

FIG. 13 is a top cross-section illustration of an impact mitigation structure according to a sixth example.

FIG. 14 is a top cross-section illustration of an impact mitigation structure according to a seventh example with an air bladder in a deflated position.

FIG. 15 is a top cross-section illustration of the impact mitigation structure of FIG. 14 with the air bladder in an inflated position.

FIG. 16 is a top cross-section illustration of an impact mitigation structure according to an eighth example in a pre-deployment position.

FIG. 17 is a top cross-section illustration of the impact mitigation structure of FIG. 16 in a deployed position.

FIG. 18 is a top cross-section illustration of an impact mitigation structure according to a ninth example.

FIG. 19 is a side cross-section illustration of the impact mitigation structure of FIG. 18.

FIG. 20 is a side cross-section illustration of an impact mitigation structure according to a tenth example.

FIG. 21 is a side cross-section illustration of an impact mitigation structure according to an eleventh example with an air bladder in a deflated position.

FIG. 22 is a top cross-section illustration of the impact mitigation structure of FIG. 22 with the air bladder in an inflated position.

FIG. 23 is a side cross-section illustration of an impact mitigation structure according to a twelfth example.

FIG. 24 is a side cross-section illustration of an impact mitigation structure according to a thirteenth example.

FIG. 25 is a side cross-section illustration of an impact mitigation structure according to a fourteenth example in a pre-impact position.

FIG. 26 is a side cross-section illustration of the impact mitigation structure according to FIG. 25 in a post-impact position.

FIG. 27 is a side cross-section illustration of an impact mitigation structure according to a fifteenth example in a pre-impact position.

FIG. 28 is a side cross-section illustration of the impact mitigation structure according to FIG. 27 in a post-impact position.

FIG. 29 is a top, schematic illustration of an impact mitigation structure according to a sixteenth example.

FIG. 30 is a top, schematic illustration of an impact mitigation structure according to a seventeenth example.

FIG. 31 is a top, schematic illustration of an impact mitigation structure according to an eighteenth example.

FIG. 32 is a top, schematic illustration of an impact mitigation structure according to a nineteenth example.

FIG. 33 is a top, schematic illustration of an impact mitigation structure according to a twentieth example.

FIG. 34 is a top cross-section illustration of an impact mitigation structure according to a twenty-first example in a pre-deployment position.

FIG. 35 is a top cross-section illustration of the impact mitigation structure of FIG. 34 in a deployed position.

FIG. 36 is a top cross-section illustration of an impact mitigation structure according to a twenty-second example in a pre-deployment position.

FIG. 37 is a top cross-section illustration of the impact mitigation structure of FIG. 36 in a deployed position.

### DETAILED DESCRIPTION

This disclosure relates to head-mounted devices that are used to show computer-generated reality (CGR) experiences to users. CGR experiences include display of computer-generated content independent of the surrounding physical environment (e.g., virtual reality), and display of computer generated content that is overlaid relative to the surrounding physical environment (e.g., augmented reality).

The head-mounted devices that are described herein include a device housing, optical modules that are positioned near the eyes of the user and a facial interface that contacts the user's face. The facial interface is formed primarily from compliant materials (e.g., soft, compressible materials) so that the device is comfortable to wear. Other portions of the head-mounted device may be formed from rigid or semi-rigid materials.

To reduce the chance of an impact with an external structure, computer-generated reality devices should be in is designated areas that are free from walls, objects, trip hazards, and other obstructions that could come in contact with the user during use of the computer-generated reality device. To mitigate an impact of the head-mounted device with respect to an external structure, the head-mounted devices that are described herein include an impact mitigation structure. An impact, as used herein, is contact of the device with an external structure and which may include application of a force greater than a threshold amount to the device. An impact may also be referred to as a dynamic loading event.

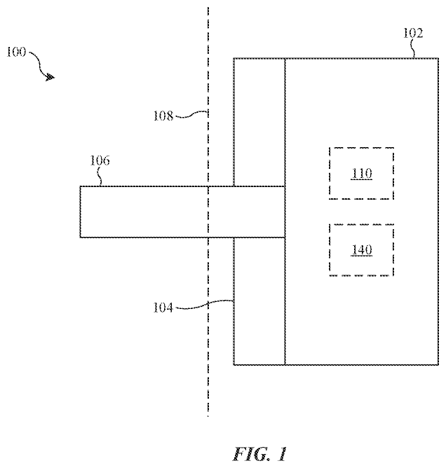

FIG. 1 is a side view schematic illustration of a head-mounted device 100. The head-mounted device 100 is worn by a user so that the user can experience CGR content that is displayed by the head-mounted device 100. The head-mounted device 100 may also be referred to as, for example, an electronic device, a wearable device, a wearable electronic device, or a wearable CGR device.

To allow to the head-mounted device 100 to be worn, the head-mounted device 100 includes structures that are able to secure the head-mounted device 100 with respect to the user's head and to support the head-mounted device 100 in a consistent position in a manner that is comfortable for the user. To output CGR content to the user, the head-mounted device 100 includes electronic components and optical components as will be described further herein. To allow the user to interact naturally with a CGR environment, the head-mounted device 100 may include components that are configured to track motion of parts of the user's body, such as the user's head and hands. Motion tracking information that is obtained by components of the head-mounted device 100 can be utilized as inputs that control aspects of the generation and display of the content to the user, thus facilitating viewing of CGR content and interaction with features that are present in CGR environments.

In the illustrated implementation, the head-mounted device 100 includes a device housing 102, a facial interface 104, and a support structure 106 that supports the device housing 102 with respect to a user so that the facial interface 104 is in contact with a face 108 of the user. The head-mounted device 100 also includes content display components 110 that are configured to cause display of the CGR content to the user. The head-mounted device 100 also includes an impact mitigation structure 140, that is configured to mitigate an impact of the head-mounted device 100 with respect to an external structure.

The device housing 102 is a rigid or semi-rigid structure that is configured to support other components that are included in the head-mounted device 100, such as by including structures that other components can be attached to or by defining an interior space that can house other components. The device housing 102 is sized and shaped to be positioned adjacent to the face 108 of the user, near the user's eyes. In the illustrated implementation, the facial interface 104 and the support structure 106 are connected to the device housing 102, the content display components 110 are located at least partly in an interior space that is defined by the device housing 102, and the impact mitigation structure 140 is either connected to the device housing 102 or located inside the device housing 102.

The facial interface 104 is a compliant structure that is connected to the device housing 102. The facial interface 104 is configured to contact the face 108 of the user is a way that makes the head-mounted device 100 comfortable to wear. The facial interface 104 can be formed partly or completely from compliant materials such as foam, silicone rubber, and textiles. The facial interface 104 may have a hollow interior. Rigid or semi rigid support structures may be located inside the facial interface 104. The impact mitigation structure 140 (or portions of it) may be located in the facial interface 104.

The support structure 106 is connected to the device housing 102 and functions to secure the device housing 102 in place with respect to the user's head so that the device housing 102 is restrained from moving with respect to the face 108 of the user and maintains a comfortable position during use. The support structure 106 may include a single component or a collection of related and/or interconnected components. The support structure 106 may implemented according to known designs for supporting head-mounted devices, such as a headband style support structure, a halo style support structure, a mohawk style support structure, or an eyeglasses style support structure (e.g., including arms that engage the sides of the user's head). In some implementations, the support structure 106 is rigid. In some implementations, the support structure 106 is flexible. In some implementations, the support structure 106 includes one or more rigid portions and one or more flexible portions.

The content display components 110 are located in the device housing 102 of the head-mounted device 100, and include electronic components and optical components that cooperate to display the CGR content to the user.

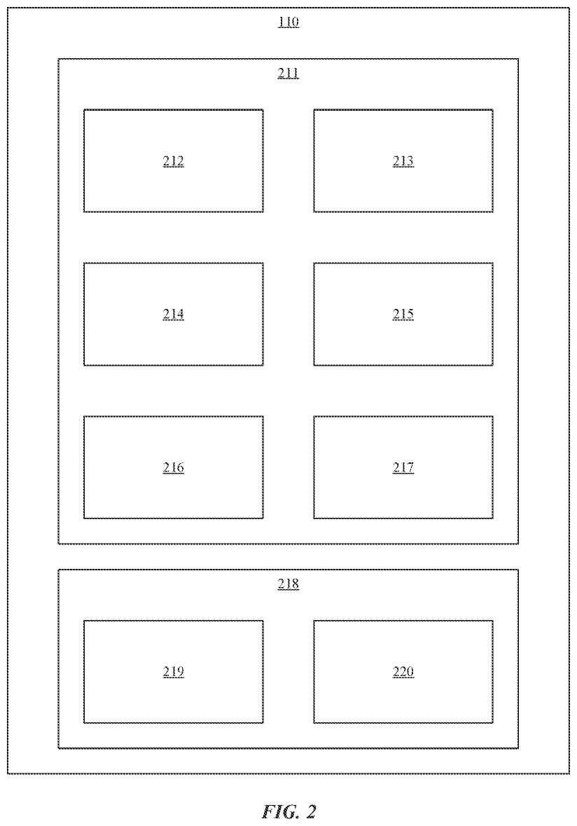

FIG. 2 is a block diagram that shows an example of the content display components 110. In the illustrated implementation, the content display components 110 include control electronics 211 and optical modules 218. The control electronics include a processor 212, a memory 213, a storage device 214, a communications device 215, sensors 216, and a power source 217. The optical modules 218 (e.g., two optical modules) each include a display device 219 and an optical system 220.

The processor 212 is a device that is operable to execute computer program instructions and is operable to perform operations that are described by the computer program instructions. The processor 212 may be implemented using one or more conventional devices and/or more or more special-purpose devices. As examples, the processor 212 may be implemented using one or more central processing units, one or more graphics processing units, one or more application specific integrated circuits, and/or one or more field programmable gate arrays. The processor 212 may be provided with computer-executable instructions that cause the processor 212 to perform specific functions. The memory 213 may be one or more volatile, high-speed, short-term information storage devices such as random-access memory modules.

The storage device 214 is intended to allow for long term storage of computer program instructions and other data. Examples of suitable devices for use as the storage device 214 include non-volatile information storage devices of various types, such as a flash memory module, a hard drive, or a solid-state drive.

The communications device 215 supports wired or wireless communications with other devices. Any suitable wired or wireless communications protocol may be used.

The sensors 216 are components that are incorporated in the head-mounted device to generate sensor output signals to are used as inputs by the processor 212 for use in generating CGR content and controlling tension, as will be described herein. The sensors 216 include components that facilitate motion tracking (e.g., head tracking and optionally handheld controller tracking in six degrees of freedom). The sensors 216 may also include additional sensors that are used by the device to generate and/or enhance the user's experience in any way. The sensors 216 may include conventional components such as cameras, infrared cameras, infrared emitters, depth cameras, structured-light sensing devices, accelerometers, gyroscopes, and magnetometers. The sensors 216 may also include biometric sensors that are operable to physical or physiological features of a person, for example, for use in user identification and authorization. Biometric sensors may include fingerprint scanners, retinal scanners, and face scanners (e.g., two-dimensional and three-dimensional scanning components operable to obtain image and/or three-dimensional surface representations). Other types of devices can be incorporated in the sensors 216. The information that is generated by the sensors 216 is provided to other components of the head-mounted device, such as the processor 212, as inputs.

The power source 217 supplies electrical power to components of the head-mounted device. In some implementations, the power source 217 is a wired connection to electrical power. In some implementations, the power source 217 may include a battery of any suitable type, such as a rechargeable battery. In implementations that include a battery, the head-mounted device may include components that facilitate wired or wireless recharging.

The optical modules 218 are assemblies that emit light in response to signals received from the processor 212 in order to output content for display to the user, and guide the emitted light to the user's eyes, for example, according to stereoscopic vision principles, in order to present the CGR experience to the user. Each of the optical modules 218 includes the display device 219 and the optical system 220. The optical modules 218 may include other components, such as a housing, a camera, other sensors, heat sinks, cooling fans, etc. As described herein, the content display components 110 include two optical modules (e.g., a left optical module and a right optical module corresponding to the user's left and right eyes), but the content display components 110 could instead include a single optical module that displays content to one of the user's eyes or a single optical module that displays content to both of the user's eyes.

The display device 219 is connected to the device housing and functions to display the content to the user in the form of emitted light that is output by the display device 219 and is directed toward the user's eyes by the optical system 220. The display device 219 is a light-emitting display device, such as a video display of any suitable type, that is able to output images in response to a signal that is received from the processor 212. The display device 219 may be of the type that selectively illuminates individual display elements (e.g., pixels) according to a color and intensity in accordance with pixel values from an image. As examples, the display device may be implemented using a liquid-crystal display (LCD) device, a light-emitting diode (LED) display device, a liquid crystal on silicon (LCoS) display device, an organic light-emitting diode (OLED) display device, or any other suitable type of display device. The display device 219 may include multiple individual display devices (e.g., two display screens or other display devices arranged side-by-side in correspondence to the user's left eye and the user's right eye).

The optical system 220 is associated with the display device 219 and is optically coupled to the display device 219. The optical system is connected to the device housing such that portions of the optical system 220 (e.g., lenses) are positioned adjacent to the user's eyes. The optical system 220 directs the emitted light from the display device 219 to the user's eyes. In some implementations, the optical system 220 may be configured isolate the emitted light from environment light (e.g., as in a virtual reality type system), so that a scene perceived by the user is defined only by the emitted light and not by the environment light. In some implementations, the optical system 220 may be configured to combine the emitted light with environmental light so that the scene perceived by the user is defined by the emitted light and the environment light. In some implementations, the optical system 220 may combine the emitted light and the environment light so that a spatial correspondence is established between the emitted light and the environmental light to define the scene that is perceived by the user (e.g., as in an augmented reality type system). The optical system 220 may include lenses, reflectors, polarizers, filters, optical combiners, and/or other optical components.

In some implementations of the head-mounted device 100, some of the content display components 110 are included in a separate device that is removable (e.g., by docking) to the other portions of the head-mounted device 100. In some implementations of the head-mounted device 100, some of the content display components 110 are omitted and the corresponding functions are performed by an external device that communicates with the head-mounted device 100, e.g., using a wired connection or a wireless connection that is established using the communications device 215.

In some implementations, the control electronics 211 may be configured to perform impact mitigation functions. As an example, using computer program instructions provided to the processor 212, the processor 212 can obtain a measurement from the sensors 216 of a distance between a part of the head-mounted device 100 (e.g., the optical modules) and the face 108 of the user. This distance can be compared to a threshold value. If the distance between the part of the head-mounted device 100 and the face 108 of the user is less than the threshold value, the processor 212 can cause an alert to be displayed to the user, indicating that the position and/or fit of the head-mounted device 100 needs to be adjusted to ensure safe operation.

With further reference to FIG. 1, the impact mitigation structure 140 is configured to mitigate an impact of the head-mounted device 100 with respect to an external structure. As one example, example, the impact mitigation structure 140 may be configured to control the pressure applied to the user by structures that are included in the head-mounted device 100. As another example, the impact mitigation structure 140 may include energy absorbers. As another example, the impact mitigation structure 140 may include components that move portions of the head-mounted device 100 away from the user during an impact.

During normal use of the head-mounted device 100, rigid portions of the head-mounted device 100 do not typically contact the user. For example, the facial interface 104 provides a compliant structure that deforms upon engagement with the face 108 of the user to define a comfortable fit of the head-mounted device 100. During an impact, portions of the head-mounted device 100, such as the device housing 102 or portions of the content display components 110 (e.g., lenses and adjacent structures) may move with respect to the user and may contact the user as a result of deformation of the facial interface. The impact mitigation structure 140 is configured to reduce an amount of pressure applied to the user or to avoid contact of particular portions of the head-mounted device 100 with the user.

In some implementations, the impact mitigation structure 140 is located inside the facial interface 104 and includes a bump stop that is located inside the facial interface 104 to disperse pressure from an impact while restraining particular portions of the head-mounted device 100 from contacting the user.

In some implementations, the impact mitigation structure 140 is located inside the facial interface and includes springs that are located between an internal support structure of the facial interface 104 and the device housing 102 in order to regulate motion of the internal support structure of the facial interface 104 with respect to the device housing 102 and to absorb energy. As one example, the impact mitigation structure 140 may include compression springs that extend along rods. As another example, the impact mitigation structure 140 may include leaf springs that regulate motion of the internal support structure with respect to the device housing 102. As another example, the impact mitigation structure 140 may include leaf springs that regulate motion of the internal support structure in combination with compression stops that limit motion of the internal support structure with respect to the device housing 102. As another example, the impact mitigation structure 140 may include an air filled damper with a small diameter air exit port that regulates movement of the internal support structure of the facial interface 104 toward the device housing 102 in order to absorb energy.

In one implementation, the impact mitigation structure 140 is located inside the facial interface and includes a non-Newtonian foam structure that is configured to absorb energy during an impact. In one implementation, the impact mitigation structure 140 is located inside the facial interface 104 and includes an inflatable bladder (e.g., inflatable structure, air bladder) that is configured to be inflated in response to an impact detection (e.g., detection of an actual impact or detection of a predicted impact) to absorb energy during the impact.

In one implementation, the impact mitigation structure 140 is located inside the facial interface 104 and includes deployable supports that deploy during an impact by pivoting into place between the device housing 102 and the internal support structure of the facial interface 104 to move the device housing 102 away from the internal support structure of the facial interface 104.

In one implementation, the impact mitigation structure 140 includes an energy absorbing material that is located on a portion of the device housing 102 that surrounds an exposed portion of the optical module 218 (e.g., a lens, housing portion, and/or trim ring) to absorb energy if the face 108 of the user moves toward contact with the exposed portion of the optical module 218 and engages the energy absorbing material.

In one implementation, the impact mitigation structure 140 includes a wall of the device housing 102 that is inflatable and surrounds an exposed portion of the optical module 218 (e.g., a lens, housing portion, and/or trim ring) and is inflated during an impact to absorb energy and avoid contact of the face 108 of the user with the exposed portion of the optical module 218.

In one implementation, the impact mitigation structure 140 includes a flexible portion of the device housing 102 that functions as an energy absorber, is connected to the optical module 218 and allows limited motion of the optical module 218 with respect to surrounding portions of the device housing 102. In this implementation, the flexible portion of the device housing 102 absorbs energy if the user contacts a portion of the optical module 218.

In one implementation, the impact mitigation structure 140 includes an energy absorbing mounting structure that supports the optical module 218 in the device housing 102 to allow energy absorption during longitudinal motion of the optical module 218 (e.g., by compression or crushing of the energy absorbing mounting structure) as a result of an impact.

In one implementation, the impact mitigation structure 140 includes a breakaway mounting structure that supports the optical module 218 in the device housing 102 to allow movement of the optical module 218 as a result of an impact. As an example, the breakaway structure could permit pivoting motion of the optical module 218 with respect to the device housing 102 of the head-mounted device 100.

In one implementation, the impact mitigation structure 140 includes a flexible rim (e.g., rubber or silicone rubber) that is located inside the facial interface 104, is stiffer than that the facial interface, and is connected to the device housing 102 to absorb energy during an impact. In one implementation, the impact mitigation structure 140 includes a flexible rim (e.g., rubber or silicone rubber) that extends around an exposed portion of the optical module 218 to absorb energy during an impact.

In one implementation, the impact mitigation structure 140 includes dampers that are located in the support structure 106 to regulate motion of the device housing 102 relative to the face 108 of the user during an impact.

In one implementation, the impact mitigation structure 140 includes a resilient energy absorbing member (e.g., rubber or silicone rubber) that is connected to the device housing and 102 engages the face 108 of the user in the brow area above the user's eyes to distribute pressure and absorb energy during an impact.

In one implementation, the impact mitigation structure 140 includes an energy absorbing ring (e.g., a compliant ring, an elastically flexible ring, etc.) that is connected to an exposed portion of the optical module 218 (e.g., on a front surface of a trim ring or housing portion that surrounds a lens of the optical module 218).

In one implementation, the impact mitigation structure 140 includes a structure that connects the facial interface 104 to the device housing 102 so that the facial interface 104 detaches from the device housing 102 or shears (e.g., slides laterally) with respect to the device housing 102 during an impact to reduce application of compressive forces to the user.

In one implementation, the impact mitigation structure 140 includes a structure that mounts the optical module 218 to the device housing 102 so that the optical module 218 pivots with respect to the user around a generally upright axis to avoid or reduce engagement of the user with the optical module 218 during an impact. In one implementation, the impact mitigation structure 140 includes a four bar linkage that mounts the optical module 218 to the device housing 102 so that the optical module 218 pivots with respect to the user around a generally upright axis to avoid or reduce engagement of the user with the optical module 218 during an impact. In one implementation, the impact mitigation structure 140 includes a structure that mounts the optical module 218 to the device housing 102 so that the optical module 218 slides outward to avoid or reduce engagement of the user with the optical module 218 during an impact.

Specific implementations of impact mitigating features that can be included in the head-mounted device 100 and utilized as the impact mitigation structure 140 will be described further herein.

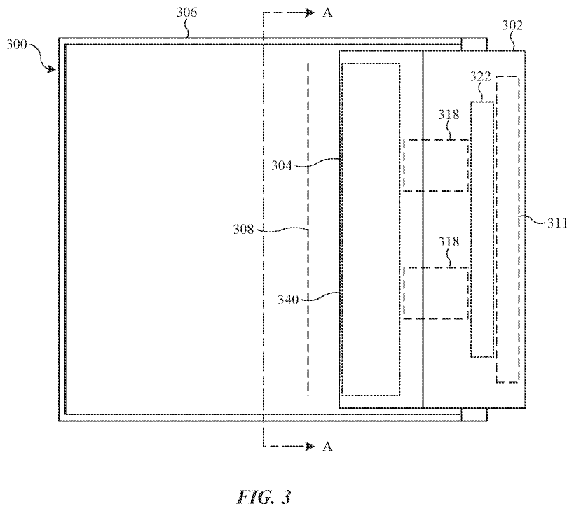

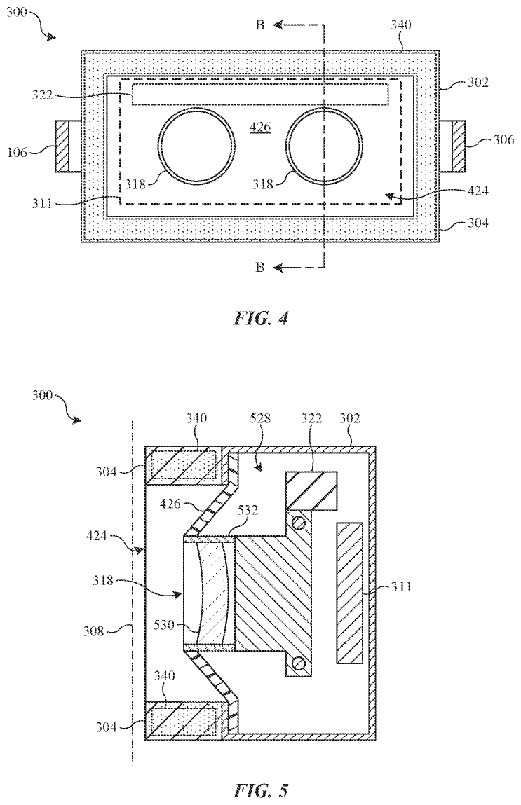

FIG. 3 is a top view illustration of a head-mounted device 300. The head-mounted device 300 includes an impact mitigation structure 340 that is located in a facial interface 304. FIG. 4 is a rear view illustration of the head-mounted device 300 taken along line A-A of FIG. 3. FIG. 5 is a cross-section illustration of the head-mounted device 300 taken along line B-B of FIG. 4.

The head-mounted device 300 is an example of an implementation of the head-mounted device 100, and the description of the head-mounted device 100 is applicable to the head-mounted device 300 except as noted herein and all features described in connection with the head-mounted device 100 can be included in the head-mounted device 300.

In the illustrated implementation, the head-mounted device 300 includes a device housing 302, a facial interface 304, and a support structure 306 that supports the device housing 302 with respect to a user so that the facial interface 304 is in contact with a face 308 of the user. The head-mounted device 300 also includes content display components that, in the illustrated implementation, are represented by control electronics 311 and optical modules 318. The control electronics 311 and the optical modules 318 can be implemented in the manner described with respect to the control electronics 211 and the optical modules 218 of the content display components 110. The head-mounted device 300 also includes an interpupillary distance adjustment mechanism 322 that is located in the device housing 302 to move the optical modules 318 to adjust a spacing between the optical modules according to a distance between the user's eyes.

The device housing 302 is a rigid or semi-rigid structure that is configured to support other components that are included in the head-mounted device 300. The device housing 302 may have a size and shape that corresponds generally to the width of the head of an average person. The device housing 302 may have a height that corresponds generally to a distance between forehead and cheek bones such that it extends above and below an average user's orbital cavities when worn. In one implementation, the device housing 302 may be a frame that other components of the head-mounted device 300 are connected to. In some implementations, the device housing 302 may be an enclosed structure so that certain components of the head-mounted device 300 are contained within the device housing 302 and thereby protected from damage. The device housing 102 may be implemented in the manner described with respect to the device housing 302.

The facial interface 304 is associated with the device housing 302 and is configured to contact the face 308 of the user. The facial interface 304 may be implemented in the manner described with respect to the facial interface 104.

As examples, the facial interface 304 may be connected to the device housing 302, the facial interface 304 may be formed on the device housing 302 (e.g., as a coating) or the facial interface 304 may be defined by features that are formed integrally on the device housing 302. The facial interface 304 may be located at areas around a periphery of the device housing 302 where contact with the user's face is likely.

The facial interface 304 functions to conform to portions of the user's face to allow the support structure 306 to be tensioned to an extent that will restrain motion of the device housing 302 with respect to the user's head. The facial interface 304 may also function to reduce an amount of light from the physical environment around the user that reaches the user's eyes. The facial interface 304 may contact areas of the user's face, such as the user's forehead, temples, and cheeks.

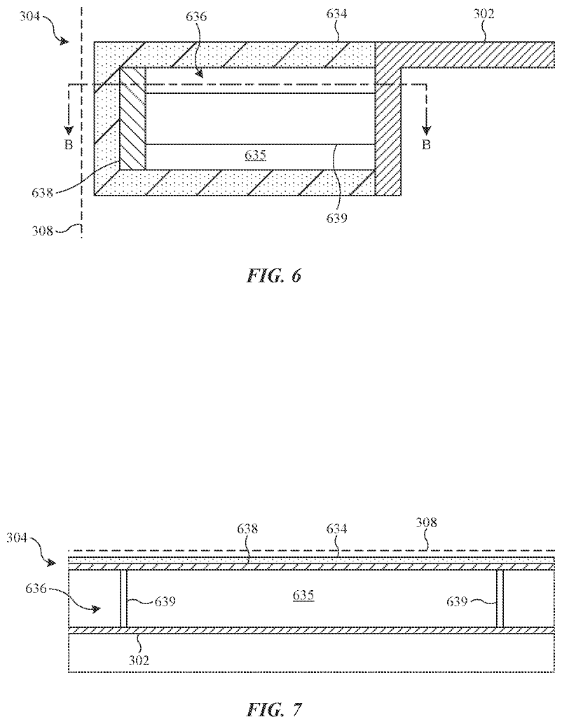

FIG. 6 is a side cross-section detail illustration of facial interface 304 taken along line B-B of FIG. 4. FIG. 7 is a top cross-section detail illustration of the facial interface 304 taken along line C-C of FIG. 6. In the illustrated implementation, the facial interface 304 includes a cover 634 and an internal support structure 636. The cover 634 is formed a compliant material so that it is able to conform to the face of the user and remain in contact as the user moves during user of the head-mounted device 300. The cover 634 may be formed from a thin layer of material, such as a sheet material. The cover 634 may be formed from, as examples, textiles, silicone rubber, open-cell foam rubber, or closed cell foam rubber. The facial interface 304 may have a soft exterior, such as a textile layer, so that it can be worn comfortably.

An internal space 635 of the facial interface 304 is located inside the cover 634, and the internal support structure 636 is located in the internal space 635 of the facial interface. The internal support structure 636 is collection of components that cooperate to define a framework that functions to define the shape of the facial interface 304 and to control deformation of the facial interface 304 in order to provide a comfortable fit for the user at to maintain contact with the user during active motion of the user during use of the head-mounted device 300. The internal support structure 636 is stiffer than the cover 634, but may be more flexible than the device housing 302.

In the illustrated example, the internal support structure 636 includes a support plate 638 and suspension members 639. The support plate 638 define a surface that is located in the cover 634 so that a portion of the cover 634 is located between the internal support structure 636 and the face 308 of the user to position the cover 634 in contact with the face 308 and to provide a reaction surface for compression of the cover 634 by the face 308. The suspension members 639 extend between the device housing 302 and the support plate 638 to hold the support plate 638 according to a desired position and orientation relative the device housing 302. The suspension members 639 may be flexible or may incorporate flexible elements to allow motion of the support plate 638 relative to the device housing 302. In some implementations, the suspension members 639 can be omitted, and their functions can be performed by the impact mitigation structure 340.

Returning to FIGS. 3-5, The support structure 306 is connected to the device housing 302. The support structure 306 is a component or collection of components that function to secure the device housing 302 in place with respect to the user's head so that the device housing 302 is restrained from moving with respect to the face 308 of the user and maintains a comfortable position during use. In some implementations, the support structure 306 is rigid. In some implementations, the support structure 306 is flexible. In some implementations, the support structure 306 includes one or more rigid portions and one or more flexible portions. The support structure 306 may be implemented in the manner described with respect to the support structure 106.

The control electronics 311 may be implemented in accordance with the description of the control electronics 211 of the content display components 110 including all subcomponents of the control electronics 211. The optical modules 318 may be implemented according to the description of the optical modules 218 of the content display components 110 including all subcomponents of the optical modules 218.

To provide comfortable contact with the face 308 of the user and to reduce an amount of ambient light that the user sees during use of the head-mounted device 300, the facial interface 304 extends around and exterior periphery of the device housing 302 as viewed from the rear and thus extends around an eye chamber 424. Thus, the facial interface 304 is adjacent to the eye chamber 424 and extends outward from the device housing 302 at the rear of the device housing 302 for contact with the face 308 rearward from the device housing 302 of the head-mounted device 300. The facial interface 304 may be continuous or discontinuous.

The eye chamber 424 is defined at the rear of the device housing 302 of the head-mounted device 300 and is the portion of the device housing 302 that is placed adjacent to the eyes of the user during use of the head-mounted device 300. The facial interface 304 is located outward from the eye chamber 424 to reduce the amount of ambient light that enters the eye chamber 424.

The eye chamber 424 is defined in part by a rear wall 426, which is a portion of the device housing 302 in the illustrated implementation by may instead be a separate structure. The rear wall 426 may be rigid, semi-rigid, or flexible. The rear wall 426 may have a rigid or semi-rigid structure with a flexible covering. The rear wall 426 separates the eye chamber 424 from an interior space 528 of the device housing 302. Components of the head-mounted device 300 may be located in the interior space 528, such as the control electronics 311.

The optical modules 318 are located partly in the interior space 528 but extend through the rear wall 426. Thus, a first portion of each of the optical modules 318 is located in the eye chamber 424 and a second portion of each of the optical modules 318 is located in the interior space 528. As an example, the optical modules 318 may each include a lens 530 and an optical module housing 532 that extends peripherally around the lens 530, where the lens 530 and the optical module housing 532 are exposed parts of the optical modules 318 that are located at least partly in the eye chamber 424 so that they are visible to the user.

The impact mitigation structure 340 may be implemented in the manner described with respect to the impact mitigation structure 140. In the illustrated implementation, the impact mitigation structure 340 is located inside the facial interface 304 and may be located in the internal space 635 that is defined inside the cover 634 of the facial interface 304. Specific implementations of the impact mitigation structure 340 will be described in the context of the embodiments that follow.

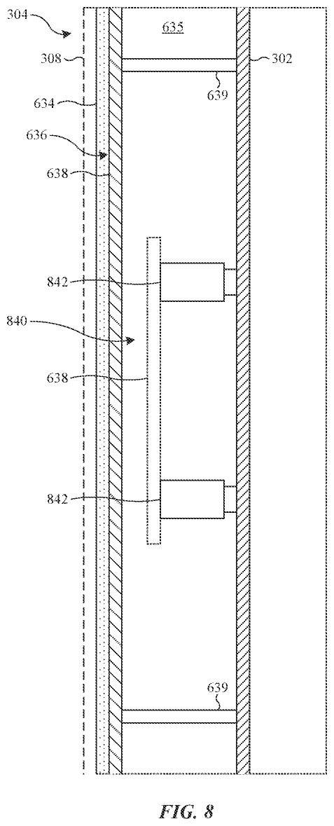

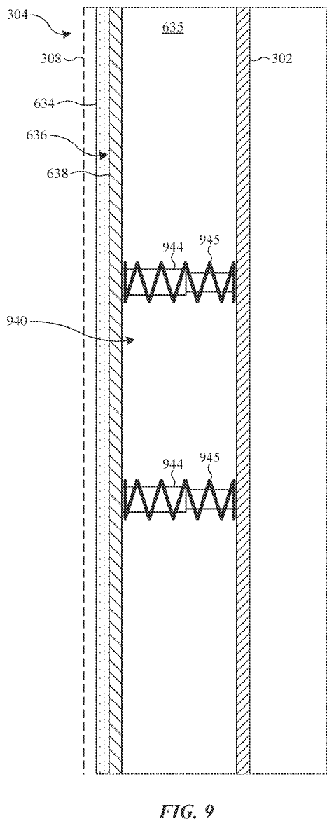

FIG. 8 is a top cross-section illustration of an impact mitigation structure 840 that can be located inside the internal space 635 of the facial interface 304 of the head-mounted device 300. The impact mitigation structure 840 is an implementation of the impact mitigation structure 340 and may be included in the head-mounted device 300 in place of the impact mitigation structure 340. The description of the head-mounted device 300 is applicable, and components described in connection with the impact mitigation structure 840 are consistent with like-named parts from the head-mounted device 300 except as noted.

The impact mitigation structure 840 and includes bump stops 842. The bump stops 842 function to disperse pressure from an impact while restraining particular portions of the head-mounted device 300 from contacting the user. The bump stops 842 may also function to apply pressure between the head-mounted device 300 and the user at predetermined locations in order to control the way that pressure from an impact is applied to the user. The bump stops 842 may also enforce a predetermined spacing between the support plate 638 and the device housing 302. This predetermined spacing can be set to avoid contact of the face 308 of the user with portions of the head-mounted device 300, such as exposed portions of the optical modules 318.

The bump stops 842 are located in inside the internal space 635 of the facial interface 304 to limit a range of motion of the internal support structure 636 of the facial interface 304. The bump stops 842 are structural components that may be, for example, cylindrical members. In the illustrated implementation, the bump stops 842 are connected to the device housing 302 near the periphery of the device housing 302 and extend toward the support plate 638 of the internal support structure 636 of the facial interface 304. As an alternative, the bump stops 842 may be formed on the support plate 638 of the internal support structure 636 of the facial interface 304 and extends toward the device housing 302.

The bump stops 842 may be rigid or may be flexible. The bump stops 842 may be stiffer than the internal support structure 636. As an example, the support plate 638 of the internal support structure 636 may move (e.g., by flexible deformation) with respect to the bump stops 842 in response to an impact until the support plate 638 contacts the bump stops 842 (shown in dotted lines), at which point the bump stops 842 restrain (e.g., stop or slow) further movement of the support plate 638 of the internal support structure 636 toward the device housing 302.

In some implementations, an impact mitigation structure is located inside the facial interface 304 and includes springs that are located between an internal support structure of the facial interface 304 and the device housing 302 in order to regulate motion of the internal support structure 636 of the facial interface 304 with respect to the device housing 302 and to absorb energy. Examples are described herein with reference to FIGS. 9-12.

FIG. 9 is a top cross-section illustration of an impact mitigation structure 940 that can be located inside the internal space 635 of the facial interface 304 of the head-mounted device 300. The impact mitigation structure 940 is an implementation of the impact mitigation structure 340 and may be included in the head-mounted device 300 in place of the impact mitigation structure 340. The description of the head-mounted device 300 is applicable, and components described in connection with the impact mitigation structure 940 are consistent with like-named parts from the head-mounted device 300 except as noted.

In the illustrated implementation, the impact mitigation structure 940 includes telescoping rods 944 and springs 945 (e.g., compression springs). The telescoping rods 944 extend between the support plate 638 and the device housing 302 and are configured to change length by telescoping to allow the support plate 638 to move toward and away from the device housing 302. The springs 945 extend between the support plate 638 and the device housing 302. A compression axis of each of the springs 945 is oriented along a line that extends between the device housing 302 and the support plate 638 (e.g., in a direction of a shortest distance between them). The springs 945 may be seated on the telescoping rods 944 so that the telescoping rods 944 extend through the springs 945 and the springs 945 extend around the telescoping rods 944. The springs 945 function to urge the support plate 638 away from the device housing 302 and to absorb energy during movement of the support plate 638 toward the device housing 302. This allows the springs 945 to absorb energy during an impact.

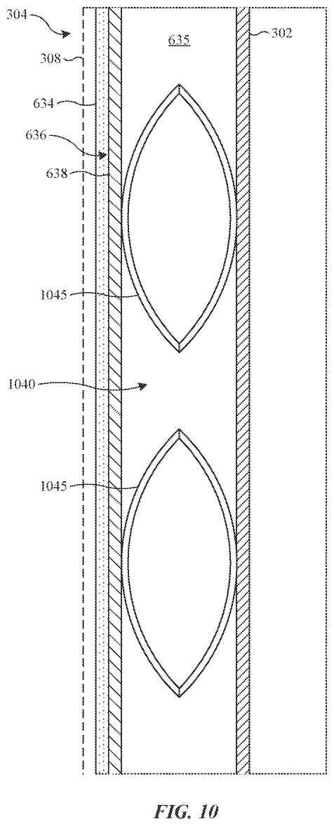

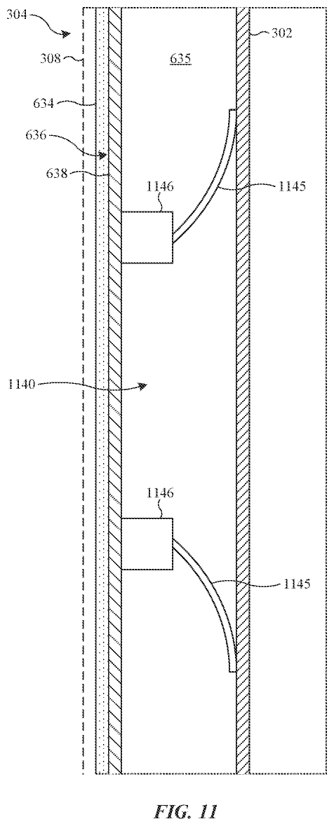

FIG. 10 is a top cross-section illustration of an impact mitigation structure 1040 that can be located inside the internal space 635 of the facial interface 304 of the head-mounted device 300. The impact mitigation structure 1040 is an implementation of the impact mitigation structure 340 and may be included in the head-mounted device 300 in place of the impact mitigation structure 340. The description of the head-mounted device 300 is applicable, and components described in connection with the impact mitigation structure 1040 are consistent with like-named parts from the head-mounted device 300 except as noted.

In the illustrated implementation, the impact mitigation structure 1040 includes leaf spring 1045 extend between the support plate 638 and the device housing 302 and are configured to change length by compression and expansion so that the support plate 638 is able to move toward and away from the device housing 302. A compression axis of each of the leaf springs 1045 is oriented along a line that extends between the device housing 302 and the support plate 638 (e.g., in a direction of a shortest distance between them). The leaf springs 1045 function to urge the support plate 638 away from the device housing 302 and to absorb energy during movement of the support plate 638 toward the device housing 302. This allows the leaf springs 1045 to absorb energy during an impact and to regulate motion of the internal support structure 636 of the facial interface 304 with respect to the device housing 102.

FIG. 11 is a top cross-section illustration of an impact mitigation structure 1140 that can be located inside the internal space 635 of the facial interface 304 of the head-mounted device 300. The impact mitigation structure 1140 is an implementation of the impact mitigation structure 340 and may be included in the head-mounted device 300 in place of the impact mitigation structure 340. The description of the head-mounted device 300 is applicable, and components described in connection with the impact mitigation structure 1140 are consistent with like-named parts from the head-mounted device 300 except as noted.

In the illustrated implementation, the impact mitigation structure 1140 includes leaf springs 1145 and stop structures 1146. In the illustrated implementation, the stop structures 1146 are connected to the support plate 638 of the internal support structure 636 and extend toward the device housing 302 to enforce a minimum spacing between the support plate 638 and the device housing 302, as explained with respect to the bump stops 842 of the impact mitigation structure 840. The leaf springs 1145 extend between the stop structures 1146 and the device housing 302 and are configured to change length by compression and expansion so that the support plate 638 is able to move toward and away from the device housing 302. A compression axis of each of the leaf springs 1145 is oriented along a line that extends between the device housing 302 and a corresponding one of the stop structures 1146 (e.g., in a direction of a shortest distance between them). The positions of the leaf springs 1145 and the stop structures 1146 could be reversed, so that the stop structures 1146 are connected to the device housing 302 and the leaf springs 1145 extend between the support plate 638 and the stop structures 1146.

The leaf springs 1145 function to urge the support plate 638 away from the device housing 302 and to absorb energy during movement of the support plate 638 toward the device housing 302. This allows the leaf springs 1145 to absorb energy during an impact and to regulate motion of the internal support structure 636 of the facial interface 304 with respect to the device housing 102. The stop structure 1146 can space the face 308 of the user from portions of the head-mounted device 300, such as the optical modules 318, to prevent contact.

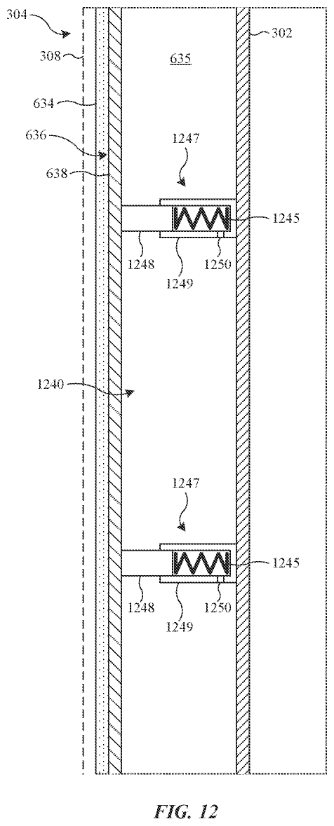

FIG. 12 is a top cross-section illustration of an impact mitigation structure 1240 that can be located inside the internal space 635 of the facial interface 304 of the head-mounted device 300. The impact mitigation structure 1240 is an implementation of the impact mitigation structure 340 and may be included in the head-mounted device 300 in place of the impact mitigation structure 340. The description of the head-mounted device 300 is applicable, and components described in connection with the impact mitigation structure 1240 are consistent with like-named parts from the head-mounted device 300 except as noted.

In the illustrated implementation, the impact mitigation structure 1240 includes air filled dampers 1247 that regulate movement of the support plate 638 of facial interface 304 toward the device housing 302 in order to absorb energy. The air filled dampers 1247 each include a piston 1248, a cylinder 1249, and an air exit port 1250.

In the illustrated implementation, the piston 1248 is connected to the support plate 638 of the internal support structure 636 and the cylinder 1249 is connected to the device housing 302, but the positions can be reversed. The piston 1248 extends into the cylinder 1249 and can move axially into and out of the cylinder 1249 in correspondence with movement of the support plate 638 with respect to the device housing 302. A maximum insertion depth of the piston 1248 with respect to the cylinder 1249 enforces a minimum spacing distance between the support plate 638 and the device housing 302. A spring 1245 (e.g., a compression spring) is located in an interior space of the cylinder 1249 and applies a spring force to the piston 1248 to urge the piston 1248 out of the cylinder 1249 and thus urge the support plate 638 away from the device housing 302.

The interior space of the cylinder 1249 is filled with air and is in fluid communication with an outside (e.g., ambient) environment through the air exit port 1250. The interior space of the cylinder 1249 is otherwise sealed. As a result, movement of the support plate 638 toward the device housing 302 is resisted by the air filled dampers 1247 according to the rate at which the air inside the interior of the air filled dampers 1247 can exit through the air exit port 1250, which allows the air filled dampers 1247 to absorb energy and regulate motion of the support plate 638 with respect to the device housing 302 during an impact. Movement of the support plate 638 toward the device housing 302 is also resisted by the spring 1245. Movement of the support plate 638 away from the device housing 302 causes air to enter the air exit port 1250 as the piston 1248 moves out of the cylinder 1249.

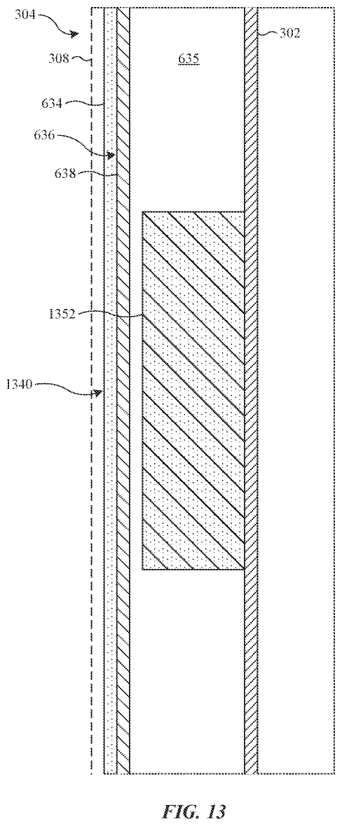

FIG. 13 is a top cross-section illustration of an impact mitigation structure 1340 that can be located inside the internal space 635 of the facial interface 304 of the head-mounted device 300. The impact mitigation structure 1340 is an implementation of the impact mitigation structure 340 and may be included in the head-mounted device 300 in place of the impact mitigation structure 340. The description of the head-mounted device 300 is applicable, and components described in connection with the impact mitigation structure 1340 are consistent with like-named parts from the head-mounted device 300 except as noted.

The impact mitigation structure 1340 includes an energy absorbing structure 1352 that is located in the internal space 635 of the facial interface 304 in order to absorb energy. The energy absorbing structure 1352 may be located between the support plate 638 of the internal support structure 636 and the device housing 302. Alternatively, the internal support structure 636 may be omitted and the energy absorbing structure 1352 may be located between the cover 634 of the facial interface 304 and the device housing 302. The energy absorbing structure 1352 may fill the internal space 635, or it may be present in localized areas and/or only engaged after a predetermined deflection of the support plate 638 of the internal support structure 636 toward the device housing 302.

In one implementation, the energy absorbing structure 1352 is a resilient energy absorbing member (e.g., rubber or silicone rubber) that is located inside the facial interface 304, for example, by being connected to the device housing and 102. The resilient energy absorbing member is formed from a material that is able to deform resiliently in response to an impact but is stiffer and has a higher energy-absorbing capacity than the components of the facial interface 304. The energy absorbing structure 1352 may engage the face 108 of the user (either directly or through portions of the facial interface 304) in the brow area above the user's eyes to distribute pressure and absorb energy during an impact.

In another implementation, the energy absorbing structure 1352 is a non-Newtonian foam structure. For example, the energy absorbing structure 1352 may be a block of non-Newtonian foam that is located inside the facial interface 304. The non-Newtonian foam structure includes a foam cushioning material (e.g., closed cell polyurethane foam rubber) that has a shear-thickening non-Newtonian fluid dispersed throughout the pore structure of the foam. Shear-thickening non-Newtonian fluids increase in viscosity in response to application of forces to the fluid. As a result, the non-Newtonian foam structure is highly flexible when low levels of force are applied, but is inflexible and stiff when high levels of force are applied. This allows the non-Newtonian foam structure to absorb energy effectively during an impact.

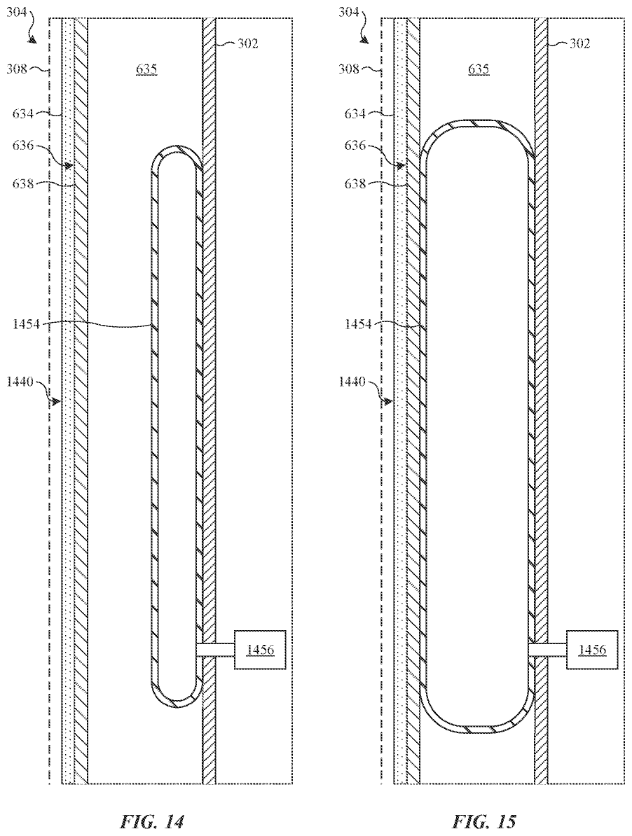

FIG. 14 is a top cross-section illustration of an impact mitigation structure 1440 that can be located inside the internal space 635 of the facial interface 304 of the head-mounted device 300 including an air bladder 1454 (e.g., an inflatable structure or an inflatable air bladder) in a deflated position. FIG. 15 is a top cross-section illustration of the impact mitigation structure 1440 with the air bladder 1454 in an inflated position. The impact mitigation structure 1440 is an implementation of the impact mitigation structure 340 and may be included in the head-mounted device 300 in place of the impact mitigation structure 340. The description of the head-mounted device 300 is applicable, and components described in connection with the impact mitigation structure 1440 are consistent with like-named parts from the head-mounted device 300 except as noted.

The head-mounted device 300 uses the control electronics 211 to identify an impact detection. An impact detection is a determination that indicates that an impact has occurred or is predicted to occur (e.g., detection of an actual impact or detection of a predicted impact). The impact detection may be identified using signals that are output by the sensors 216 of the control electronics 211 and processed by the processor 212, which can determine whether an impact detection should be identified using computer program instructions. As one example, the processor 212 can output an impact detection when a motion characteristic (e.g., acceleration) is greater than a threshold value. As another example, the processor 212 can output an impact detection when a fixed object is sensed near the head-mounted device 300, and, based a current trajectory of the head-mounted device 300, a predicted future position of the head-mounted device 300 corresponds to an impact.

The air bladder 1454 is initially in the deflated position (FIG. 14) inside the facial interface 304 (e.g., between the device housing 302 and the support plate 638). In response to the impact detection, an inflation system 1456 is activated to supply gas to the air bladder 1454, which causes the air bladder 1454 to inflate, which is represented by the inflated position (FIG. 15). The inflation system 1456 may include, as examples, a compressed air cartridge or a pyrotechnic inflator. In the inflated position, the air bladder 1454 is expanded so that it is able to absorb energy and resist compression of the facial interface 304. As an example, in the inflated position, the air bladder 1454 may maintain a predetermined spacing between the support plate 638 and the device housing 302.

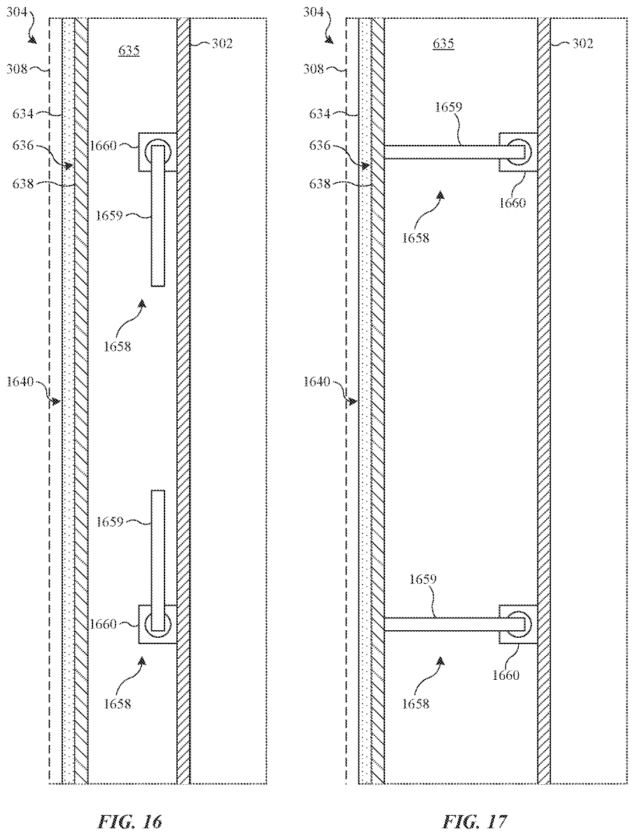

FIG. 16 is a top cross-section illustration of an impact mitigation structure 1640 that can be located inside the internal space 635 of the facial interface 304 of the head-mounted device 300 in a pre-deployment position and FIG. 17 is a top cross-section illustration of the impact mitigation structure 1640 in a deployed position. The impact mitigation structure 1640 is an implementation of the impact mitigation structure 340 and may be included in the head-mounted device 300 in place of the impact mitigation structure 340. The description of the head-mounted device 300 is applicable, and components described in connection with the impact mitigation structure 1640 are consistent with like-named parts from the head-mounted device 300 except as noted.

The impact mitigation structure 1640 includes deployable supports 1658. The deployable supports are configured to be deployed for an impact and space the support plate 638 from the device housing 302 to prevent contact by the face 108 with the device housing 302 or associated structures, such as the optical modules 318. The deployable supports 1658 deploy during an impact by pivoting into place between the device housing 302 and the internal support structure 636 (e.g., the support plate 638) to move the device housing 102 away from internal support structure 636 of the facial interface 304. This allows the facial interface 304 to space the device housing 302 and associated components (e.g., the optical modules 318) from the face 308 of the user.

In the illustrated implementation, the deployable supports 1658 include support members 1659 and actuators 1660. The support members 1659 are structural components that extend along the front of the device housing 302 in a pre-deployment position and extend between the device housing 302 and the internal support structure 636 in a deployed position. The actuators 1660 cause the support members 1659 to move from the pre-deployment position to the deployed position in response to an impact detection (e.g., from the control electronics 211 as previously described with respect to the impact mitigation structure 1440). As one example, the actuators 1660 may be rotary actuators configured to pivot the support members 1659. As one example, the support members 1659 may be spring biased to the deployed position and the actuators 1660 may be actuatable release mechanisms (e.g., mechanical catch that disengages by activation of a solenoid).

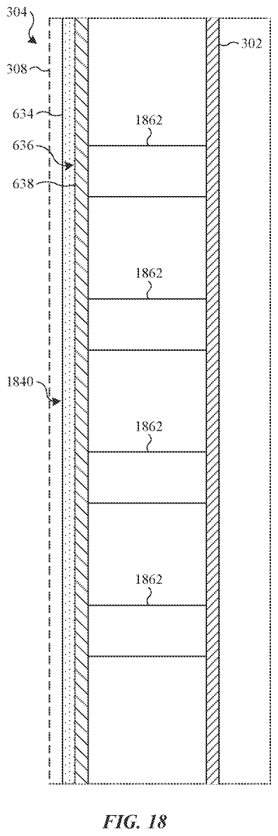

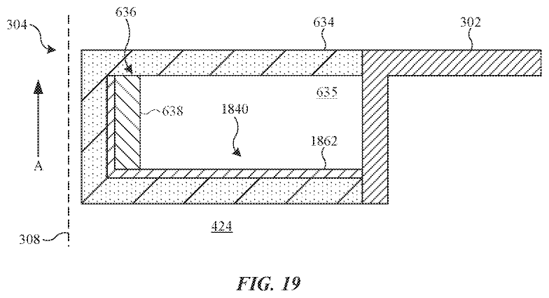

FIG. 18 is a top cross-section illustration of an impact mitigation structure 1840 that can be located inside the internal space 635 of the facial interface 304 of the head-mounted device 300. FIG. 19 is a side cross-section illustration of the impact mitigation structure 1840. The impact mitigation structure 1840 is an implementation of the impact mitigation structure 340 and may be included in the head-mounted device 300 in place of the impact mitigation structure 340. The description of the head-mounted device 300 is applicable, and components described in connection with the impact mitigation structure 1840 are consistent with like-named parts from the head-mounted device 300 except as noted.

The impact mitigation structure 1840 includes an energy absorbing members 1862 that are is located in the internal space 635 of the facial interface 304 in order to absorb energy. As examples, the energy absorbing members 1862 may be formed from rubber, silicone rubber, or plastics.

The energy absorbing members 1862 extend outward from the device housing 302 along an interior surface of the cover 634 of the facial interface 304 toward a rearward portion of the facial interface 304 (e.g., toward a location where the facial interface 304 contacts the face 308 of the user. The energy absorbing members 1862 may be located between the support plate 638 of the internal support structure 636 and the device housing 302 or a portion of the energy absorbing members 1862 may extend between the cover 634 and the internal support structure 636 of the facial interface 304. Alternatively, the internal support structure 636 may be omitted.

Multiple ones of the energy absorbing members 1862 may be located at spaced locations along the interior of the facial interface 304 and each define portions of a flexible rim inside the facial interface 304. Alternatively, the energy absorbing members 1862 may instead be a single structure that defines a flexible rim inside the facial interface 304. The flexible rim that is defined by the energy absorbing members 1862 is stiffer than that the facial interface 304 (e.g., the cover 634 of the facial interface 304), and is connected to the device housing 302 to absorb energy during an impact. The flexible rim that is defined by the energy absorbing members 1862 may deform outward relative to the eye chamber 424 (in the direction of arrow A of FIG. 19) during an impact and absorb energy during deformation.

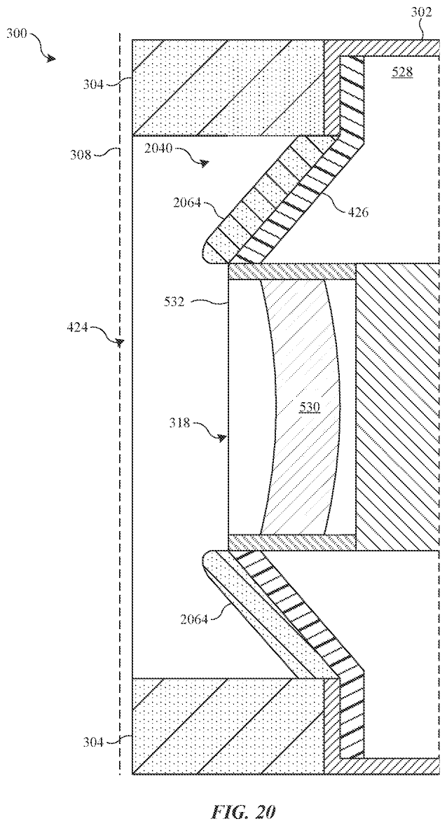

In the preceding implementations, the impact mitigation structure is located in the facial interface 304 as described with respect to the impact mitigation structure 340. In the implementations that follow, specifically in FIGS. 20-24, the impact mitigation structure is located in the eye chamber 424 of the head-mounted device 300. The description of the head-mounted device 300 remains applicable, with the impact mitigation structures being usable in lieu or in combination with impact mitigation structures that are located in the facial interface 304 as previously described.

FIG. 20 is a side cross-section illustration of an impact mitigation structure 2040 that can be located inside the eye chamber 424 of the device housing 302 of the head-mounted device 300. The impact mitigation structure 2040 may be included in the head-mounted device 300 in place of the impact mitigation structure 340 or in addition to the impact mitigation structure 340. The description of the head-mounted device 300 is applicable, and components described in connection with the impact mitigation structure 2040 are consistent with like-named parts from the head-mounted device 300 except as noted.

The impact mitigation structure 2040 includes an energy absorbing material 2064 that is located on a portion of the device housing 102. The energy absorbing material 2064 surrounds an exposed portion of each of the optical modules 318 (e.g., the lens 530 and/or the optical module housing 532). In the illustrated implementation, the energy absorbing material 2064 is located in the eye chamber 424 and is disposed on the rear wall 426 of the device housing 302, which extends around exposed portions of the optical modules 318 in the eye chamber 424 as previously described.

At least part of the energy absorbing material 2064 is located outward (e.g., toward the face 308 of the user) relative to the optical modules 318 so that the face 308 of the user will contact the energy absorbing material 2064 upon moving toward the optical modules 318 during an impact. Thus, the energy absorbing material 2064 is configured to absorb energy if the user moves toward contact with the exposed portion of the optical modules 318 and engages the energy absorbing material 2064.

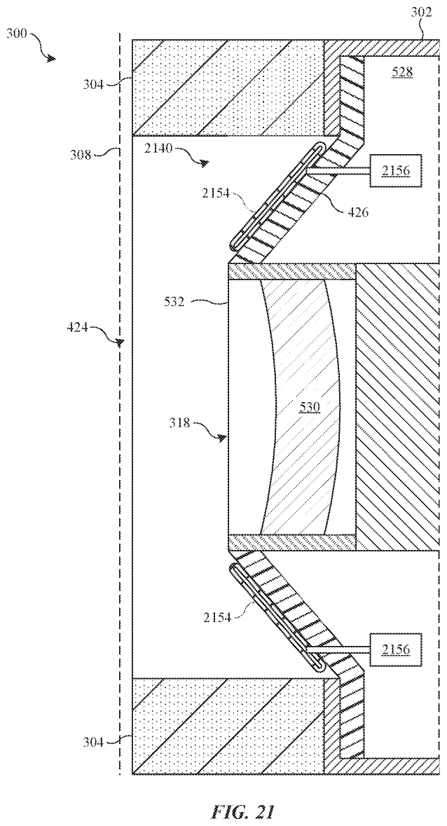

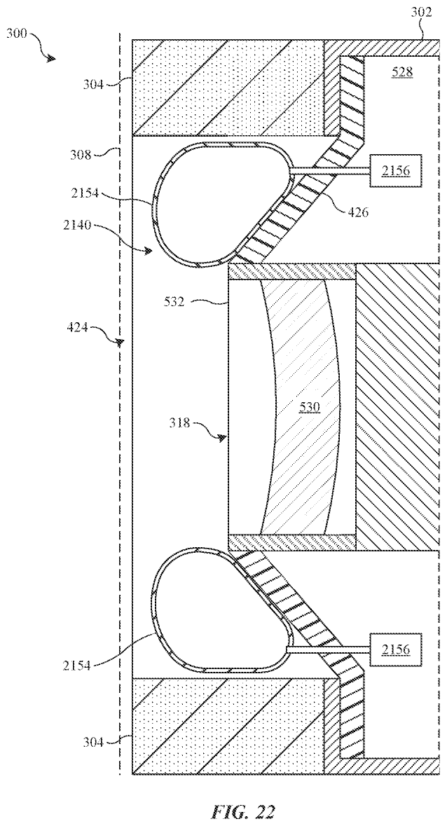

FIG. 21 is a side cross-section illustration of an impact mitigation structure 2140 that can be located inside the eye chamber 424 of the device housing 302 of the head-mounted device 300 and includes an air bladder 2154 (e.g., an inflatable structure or an inflatable air bladder) in a deflated position. FIG. 22 is a side cross-section illustration of an impact mitigation structure 2140 showing the air bladder 2154 in an inflated position. The impact mitigation structure 2140 may be included in the head-mounted device 300 in place of the impact mitigation structure 340 or in addition to the impact mitigation structure 340. The description of the head-mounted device 300 is applicable, and components described in connection with the impact mitigation structure 2140 are consistent with like-named parts from the head-mounted device 300 except as noted.

The air bladder 2154 is located in the eye chamber 424 and is located on or formed integrally with the rear wall 426 of the device housing 302. Thus, the air bladder 2154 extends around an exposed portion of each of the optical modules 318 (e.g., the lens 530 and/or the optical module housing 532). In the deflated position (FIG. 21), the exposed portions of the optical modules 318 may be closer to the face 308 of the user than the air bladder 2154. In the inflated position (FIG. 22), the air bladder 2154 extends outward relative to the rear wall 426 of the device housing 302 and is closer to the face 308 of the user than the exposed portions of the optical modules 318.

The air bladder 2154 is initially in the deflated position (FIG. 21). The head-mounted device 300 uses the control electronics 211 to identify an impact detection, which is used to trigger an inflation system 2156 (which is equivalent to the inflation system 1456), which causes the air bladder to inflate from the deflated position (FIG. 21) to the inflated position (FIG. 22).

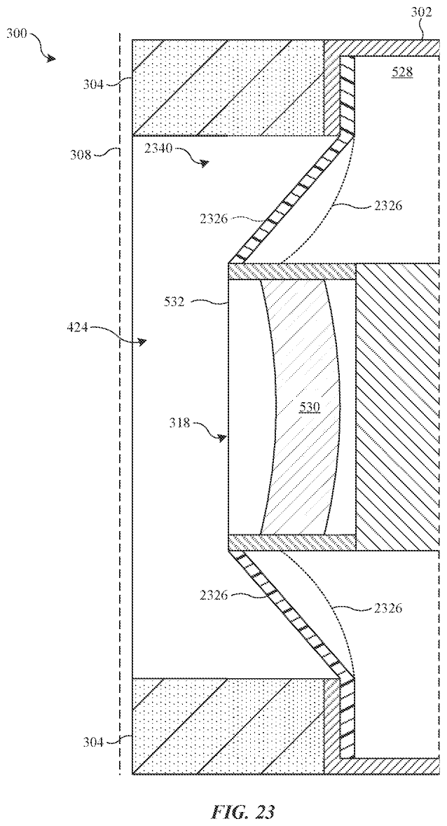

FIG. 23 is a side cross-section illustration of an impact mitigation structure 2340 that can be located inside the eye chamber 424 of the device housing 302 of the head-mounted device 300. The impact mitigation structure 2340 may be included in the head-mounted device 300 in place of the impact mitigation structure 340 or in addition to the impact mitigation structure 340. The description of the head-mounted device 300 is applicable, and components described in connection with the impact mitigation structure 2340 are consistent with like-named parts from the head-mounted device 300 except as noted.

The impact mitigation structure 2340 includes a flexible rear wall 2326 that replaces the rear wall 426. The flexible rear wall 2326 is implemented according to the description of the rear wall 426 except that it is formed from a flexible material that is able to deform resilient upon contact, for example, with the face 308 of the user. For example, upon contact by an external structure the flexible rear wall 2326 may move to a deflected position, as depicted in dotted lines. Exposed portions of the optical modules 318 are mounted to the flexible rear wall 2326, such as the lens 530 and the optical module housing 532 of the optical modules 318 so that they move with the flexible rear wall 2326 and can cause deflection of the flexible rear wall 2326 if contacted. Thus, the flexible rear wall 2326 is a flexible portion of the device housing 302 that functions as an energy absorber, is connected to the optical modules 318 and allows limited motion of the optical modules 318 with respect to surrounding portions of the device housing 302. This allows the flexible rear wall 2326 to serve as a flexible portion of the device housing 302 that absorbs energy if the face 308 of the user contacts a portion of the optical modules 318.

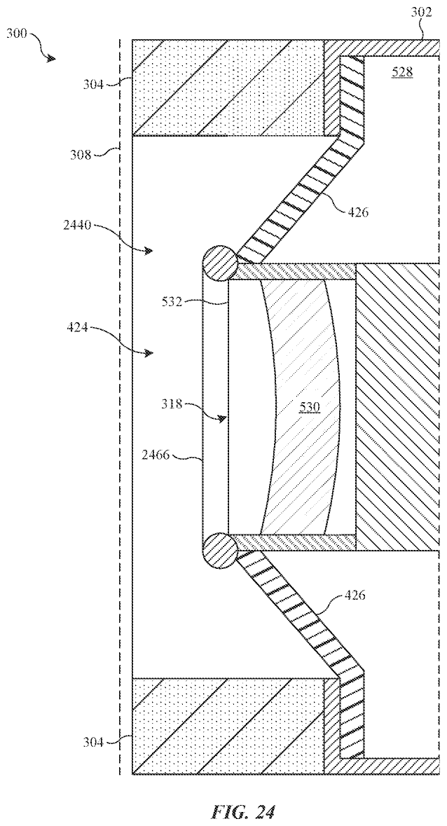

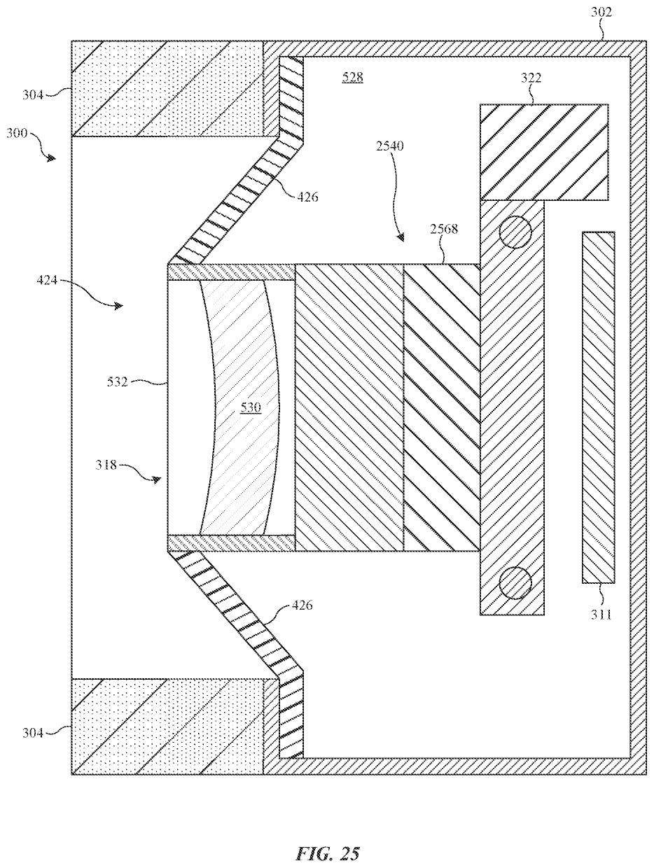

FIG. 24 is a side cross-section illustration of an impact mitigation structure 2440 that can be located inside the eye chamber 424 of the device housing 302 of the head-mounted device 300. The impact mitigation structure 2440 may be included in the head-mounted device 300 in place of the impact mitigation structure 340 or in addition to the impact mitigation structure 340. The description of the head-mounted device 300 is applicable, and components described in connection with the impact mitigation structure 2440 are consistent with like-named parts from the head-mounted device 300 except as noted.

The impact mitigation structure 2440 includes energy absorbing rings 2466. The energy absorbing rings 2466 provide a compliant, pressure spreading surface that is positioned in the eye chamber 424 of the head-mounted device 300 to avoid contact of the face 308 of the user with components of the head-mounted device 300, such as exposed portions of the optical modules 318.

The energy absorbing rings 2466 may be formed similar to an O-ring, having, as examples, a round cross-section, a square cross-section, a rectangular cross-section, or a curved cross-section (e.g., flared radially outward). The energy absorbing rings 2466 may be in the form of flexible rims that re connected to the optical module housing 532 and extend outward therefrom to absorb energy during an impact. The energy absorbing rings 2466 are each formed from a compliant and elastically flexible, and may be referred to as a compliant ring, or an elastically flexible ring. As one example, the energy absorbing rings 2466 may be formed from an elastomeric material so that they spread to distribute pressure. The energy absorbing rings 2466 may incorporate a structure that expands upon application of pressure, such as a flapped structure or a webbed structure.

The energy absorbing rings 2466 are located in the eye chamber 424 connected to an exposed portion of a respective one of the optical modules 318 and extend outward toward the face 308 of the user from the optical modules 318. In the illustrated implementation, the energy absorbing ring 2466 is located on a front surface of the optical module housing 532 of the optical modules 318 so that it extends around the outer periphery of the lens 530 of each of the optical modules 318. The energy absorbing ring 2466 may alternatively extend around an outer periphery of the optical module housing 532.

In the head-mounted device 300, the impact mitigation structure is located in the facial interface 304 as described with respect to the impact mitigation structure 340. In the implementations that follow, specifically in FIGS. 25-28, the impact mitigation structure is located in the interior space 528 of the device housing 302 of the head-mounted device 300. The description of the head-mounted device 300 remains applicable, with the impact mitigation structures being usable in lieu or in combination with impact mitigation structures that are located in the facial interface 304 and/or in the eye chamber 424 as previously described.

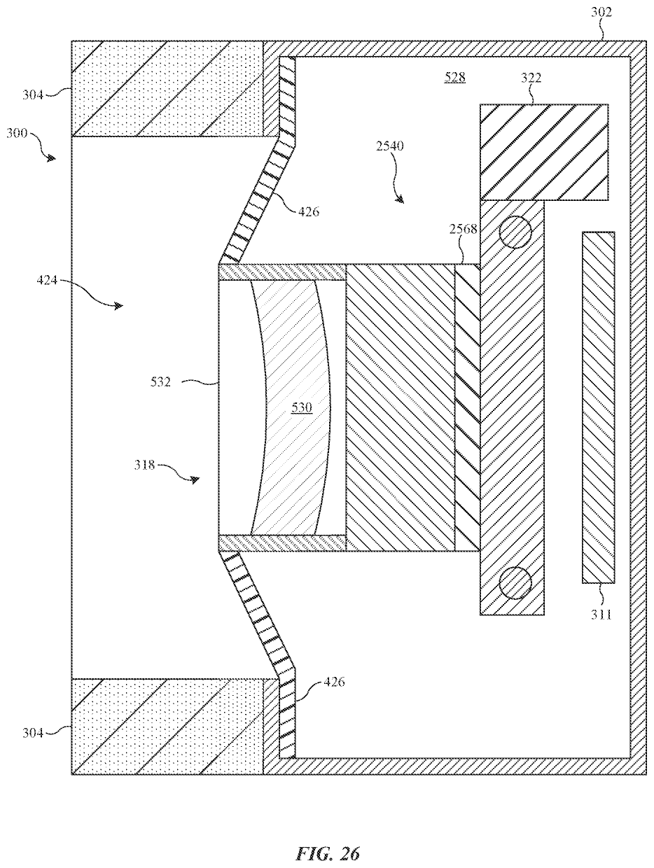

FIG. 25 is a side cross-section illustration of an impact mitigation structure 2540 that can be located inside the interior space 528 of the device housing 302 of the head-mounted device 300 in a pre-impact position. FIG. 26 is a side cross-section illustration of the impact mitigation structure 2540 in a post-impact position. The impact mitigation structure 2540 may be included in the head-mounted device 300 in place of the impact mitigation structure 340 or in addition to the impact mitigation structure 340. The description of the head-mounted device 300 is applicable, and components described in connection with the impact mitigation structure 2540 are consistent with like-named parts from the head-mounted device 300 except as noted.

The impact mitigation structure 2540 includes an energy absorbing mounting structure 2568 that supports the optical modules 318 in the device housing 102. The energy absorbing mounting structure 2568 is configured to absorb energy in response to forces applied to the optical modules 318 (e.g., as a result of contact with the face 308 of the user) that cause longitudinal motion of the optical modules 318 to allow energy absorption during longitudinal motion of the optical modules 318.

In the illustrated example, the energy absorbing mounting structure 2568 is connected to the optical modules 318 and to the interpupillary distance adjustment mechanism 322 so that the energy absorbing mounting structure 2568 is positioned between the optical modules 318 and the interpupillary distance adjustment mechanism 322. Alternatively, the optical modules 318 could be connected to the device housing 302 directly by the energy absorbing mounting structure 2568. Alternatively, the optical modules 318 could be connected to the housing through the energy absorbing mounting structure 2568 by connecting the energy absorbing mounting structure 2568 between the device housing 302 and the optical modules 318.

As one example, the energy absorbing mounting structure 2568 can include a crushable material that crushes to allow movement of the optical modules 318 from the pre-impact position (FIG. 25) to the post impact position (FIG. 26). As another example, the energy absorbing mounting structure 2568 can include a compressible material that compresses to allow movement of the optical modules 318 from the pre-impact position (FIG. 25) to the post impact position (FIG. 26).

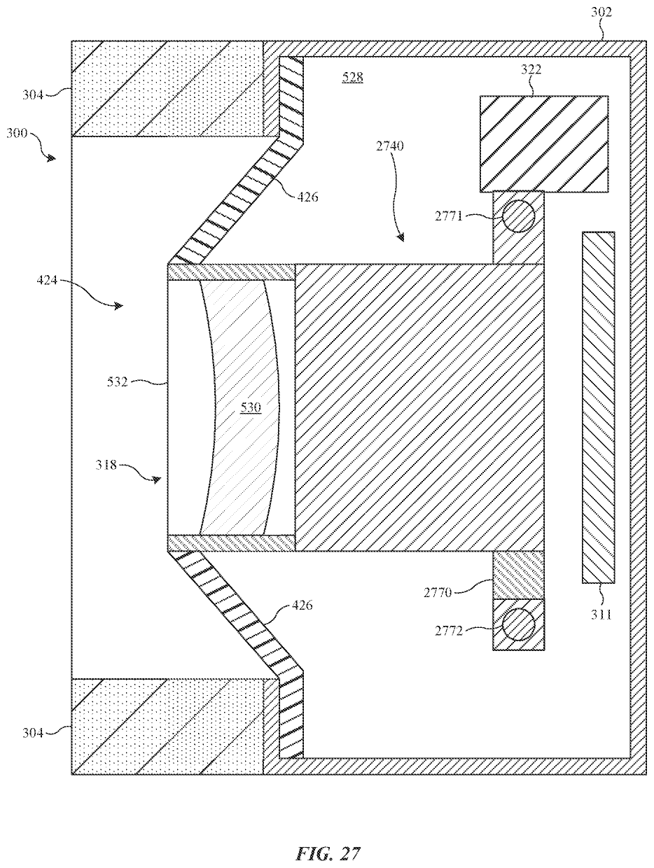

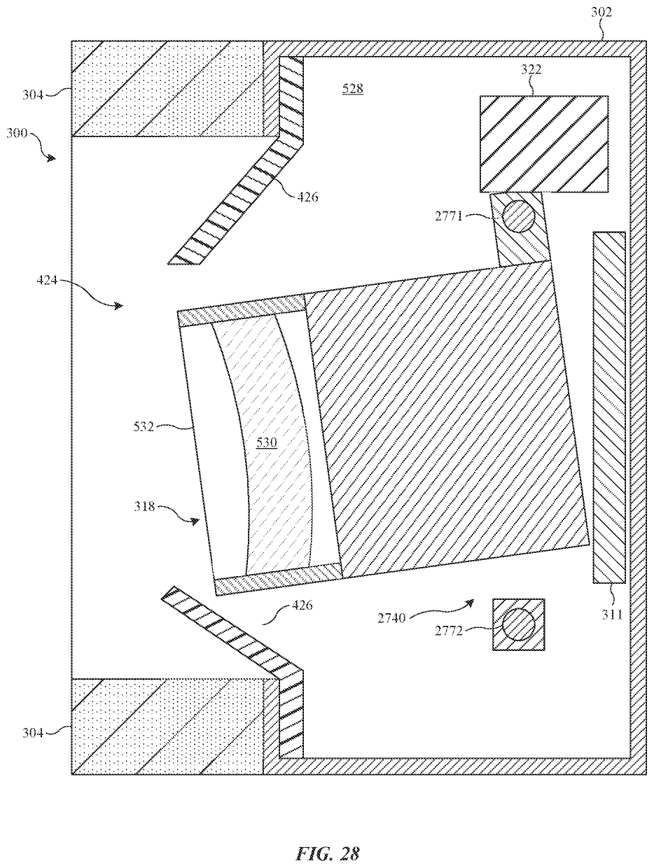

FIG. 27 is a side cross-section illustration of an impact mitigation structure 2740 that can be located inside the interior space 528 of the device housing 302 of the head-mounted device 300 in a pre-impact position. FIG. 28 is a side cross-section illustration of the impact mitigation structure 2740 in a post-impact position. The impact mitigation structure 2740 may be included in the head-mounted device 300 in place of the impact mitigation structure 340 or in addition to the impact mitigation structure 340. The description of the head-mounted device 300 is applicable, and components described in connection with the impact mitigation structure 2740 are consistent with like-named parts from the head-mounted device 300 except as noted.

The impact mitigation structure 2740 includes a breakaway mounting structure 2770. The breakaway mounting structure 2770 is configured to break during an impact, which allows the optical modules 318 to move with respect to the device housing 302 of the head-mounted device 300.

In the illustrated example, the optical modules 318 are supported by the interpupillary distance adjustment mechanism 322, which includes an upper rail 2771 and a lower rail 2772 that the optical modules 318 are able to slide laterally on for adjustment. The optical modules 318 are each connected to the lower rail 2772 of the interpupillary distance adjustment mechanism 322 by the breakaway mounting structure 2770 in the pre-impact position (FIG. 27). The breakaway mounting structure 2770 is configured to break in response to forces applied to the optical modules 318 (e.g., as a result of contact with the face 308 of the user) that cause longitudinal motion of the optical modules 318. In the illustrated example, when the breakaway mounting structure 2770 breaks (FIG. 28) the optical modules 318 is able to move away from the face 308 of the user. In the illustrated example, the optical modules 318 pivots on the upper rail 2771 of the interpupillary distance adjustment mechanism 322 when the breakaway mounting structure 2770 breaks.

Alternatively, the optical modules 318 could be connected to the device housing 302 directly by the breakaway mounting structure 2770. Alternatively, the optical modules 318 could be connected to the housing through the breakaway mounting structure 2770 by connecting the breakaway mounting structure 2770 between the device housing 302 and the optical modules 318.

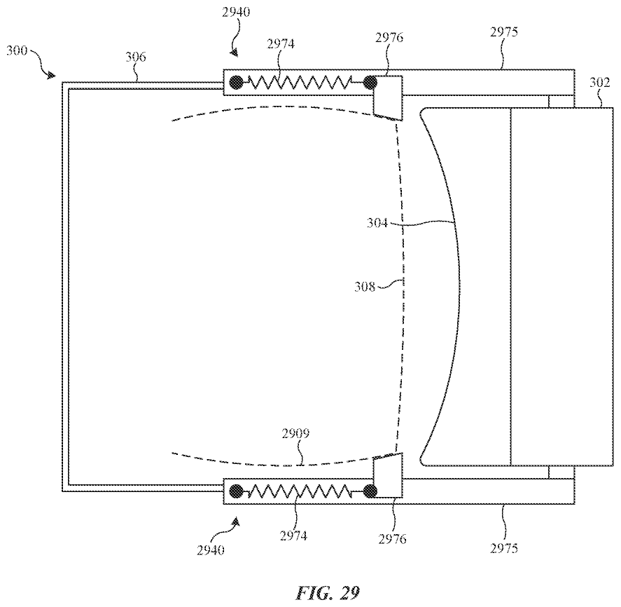

FIG. 29 is a top, schematic illustration of an impact mitigation structure 2940 that is located in the support structure 306 of the head-mounted device 300. The impact mitigation structure 2940 may be included in the head-mounted device 300 in place of the impact mitigation structure 340 or in addition to the impact mitigation structure 340. The description of the head-mounted device 300 is applicable, and components described in connection with the impact mitigation structure 2940 are consistent with like-named parts from the head-mounted device 300 except as noted.

In one implementation, the impact mitigation structure 2940 includes dampers 2974 that are located in the support structure 306 to regulate motion of the device housing 302 relative to the face 308 of the user during an impact. As examples, the dampers 2974 may be springs, liquid filled piston-cylinder dampers, or gas filled piston-cylinder dampers. At each side of the device housing 302, the support structure 306 is connected to the device housing 302 and includes housing portions 2975 and engaging portions 2976. The engaging portions 2976 are connected to the housing portions 2975 such that they extend inward from the housing portions 2975 toward the user, and are engageable with respect to a head 2909 of the user. The engaging portions 2976 are also connected to the dampers 2974 so that the dampers 2974 resist rearward travel (e.g., movement of the device housing 302 toward the face 308 of the user) of the first portions with respect to the engaging portions 2976. Thus, the dampers 2974 are able to resist motion of the face 308 of the user toward the device housing 302 and absorb energy.

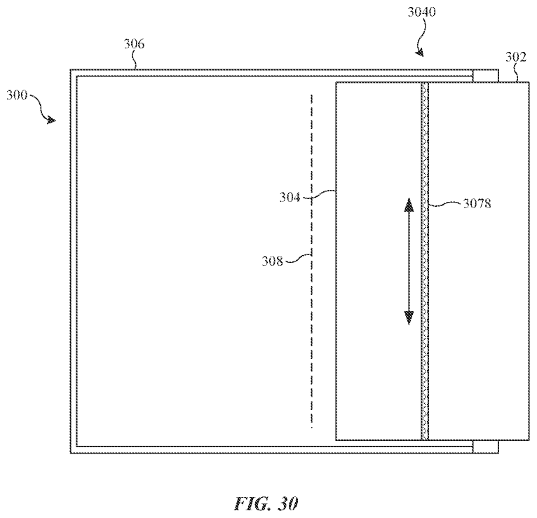

FIG. 30 is a top, schematic illustration of an impact mitigation structure 3040 of the head-mounted device 300. The impact mitigation structure 3040 may be included in the head-mounted device 300 in place of the impact mitigation structure 340 or in addition to the impact mitigation structure 340. The description of the head-mounted device 300 is applicable, and components described in connection with the impact mitigation structure 3040 are consistent with like-named parts from the head-mounted device 300 except as noted.

The impact mitigation structure 3040 includes a slip plane connector 3078. The slip plane connector 3078 is a structure that connects the facial interface 304 to the device housing 302 so that the facial interface 304 is able to slide laterally (e.g., shears) in the direction indicated by the arrow and/or detach from the device housing 302 during an impact to reduce application of compressive forces and rotational forces to the user. The slip plane connector 3078 may include complementary mating structures on the facial interface 304 and the device housing 302, such as tracks and grooves that extend in a lateral direction relative to the device housing 302 and that are configured to allow sliding or detachment in response to forces that exceed a mechanically-tuned force threshold. Thus, in response to an impact, the facial interface 304 can slide laterally with respect to the device housing 302 to reduce transmission of forces and torque from the device housing 302 to the user through the facial interface 304.

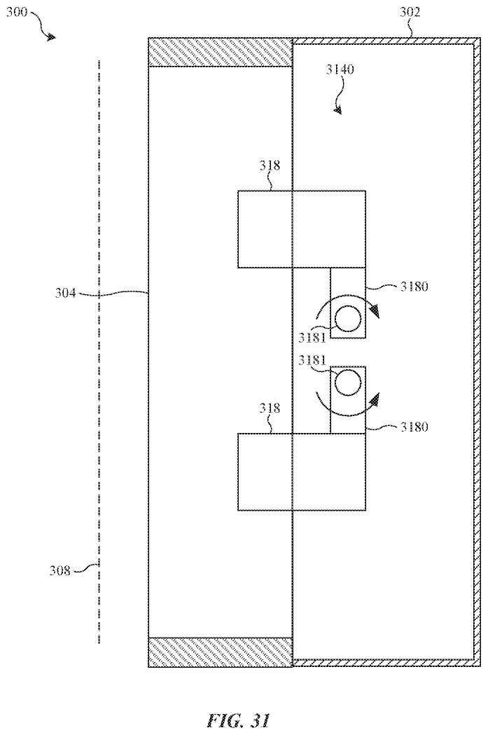

FIG. 31 is a top, schematic illustration of an impact mitigation structure 3140 of the head-mounted device 300. The impact mitigation structure 3140 may be included in the head-mounted device 300 in place of the impact mitigation structure 340 or in addition to the impact mitigation structure 340. The description of the head-mounted device 300 is applicable, and components described in connection with the impact mitigation structure 3140 are consistent with like-named parts from the head-mounted device 300 except as noted.

The impact mitigation structure 3140 includes a mounting structure 3180 for each of the optical modules 318. The mounting structure 3180 includes a pivot joint 3181 that pivotally connects each of the optical modules 318 to the device housing 302 (optionally through another structure such as the interpupillary distance adjustment mechanism 322) so that each of the optical modules 318 is able to pivot with respect to the device housing 302, and therefore with respect to the face 308 of the user, around a generally upright axis. This avoids or reduces engagement of the user with the optical modules 318 during an impact by pivoting away from the face 308 of the user in the directions indicated by the arrows. The pivot joints 3181 can be configured to resist pivoting below a threshold force.

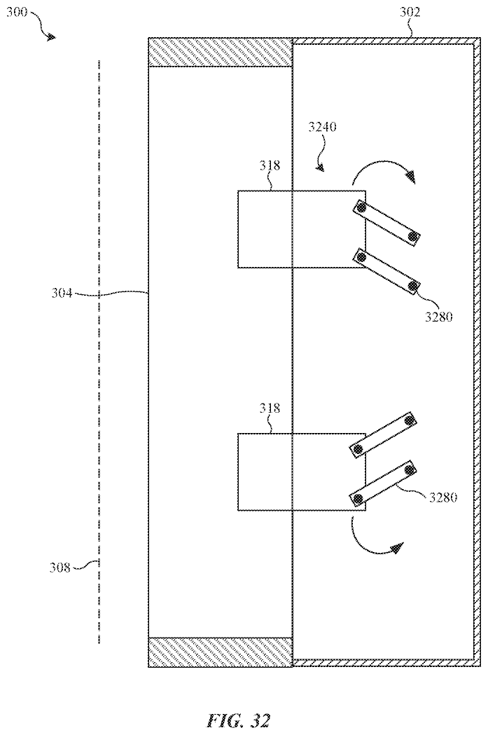

FIG. 32 is a top, schematic illustration of an impact mitigation structure 3240 of the head-mounted device 300. The impact mitigation structure 3240 may be included in the head-mounted device 300 in place of the impact mitigation structure 340 or in addition to the impact mitigation structure 340. The description of the head-mounted device 300 is applicable, and components described in connection with the impact mitigation structure 3240 are consistent with like-named parts from the head-mounted device 300 except as noted.

The impact mitigation structure 3240 includes four bar linkages 3280 that support each of the optical modules 318. The four bar linkages 3280 are connected to the optical modules 318 and a component of the head-mounted device 300, such as the device housing 302 or the interpupillary distance adjustment mechanism 322. The four bar linkages 3280 allow each of the optical modules 318 is able to pivot with respect to the device housing 302, and therefore with respect to the face 308 of the user, around a generally upright axis. This avoids or reduces engagement of the user with the optical modules 318 during an impact by pivoting away from the face 308 of the user in the directions indicated by the arrows. The four bar linkages 3280 can be configured to resist pivoting below a threshold force.

FIG. 33 is a top, schematic illustration of an impact mitigation structure 3340 of the head-mounted device 300. The impact mitigation structure 3340 may be included in the head-mounted device 300 in place of the impact mitigation structure 340 or in addition to the impact mitigation structure 340. The description of the head-mounted device 300 is applicable, and components described in connection with the impact mitigation structure 3340 are consistent with like-named parts from the head-mounted device 300 except as noted.

The impact mitigation structure 3340 includes sliding mounts 3380 that connect the optical modules 318 to the device housing 302 either directly or through another structure. The sliding mounts 3380 may, in some implementations, be part of the interpupillary distance adjustment mechanism 322. The sliding mounts 3380 mount the optical modules 318 to the device housing 302 so that the optical modules 318 slide outward (e.g., according to the arrows) to avoid or reduce engagement of the user with the optical modules 318 during an impact. As an example, the sliding mounts 3380 can be mechanically actuated (e.g., spring loaded) devices that are activated to slide the optical modules 318 outward in response to a force applied to the optical modules 318 that exceeds a threshold force. As another example, the sliding mounts 3380 may be electromechanical, including motors (e.g., as part of the interpupillary distance adjustment mechanism 322) that are activated in response to an impact detection (as previously described) to move the optical modules 318 outward.

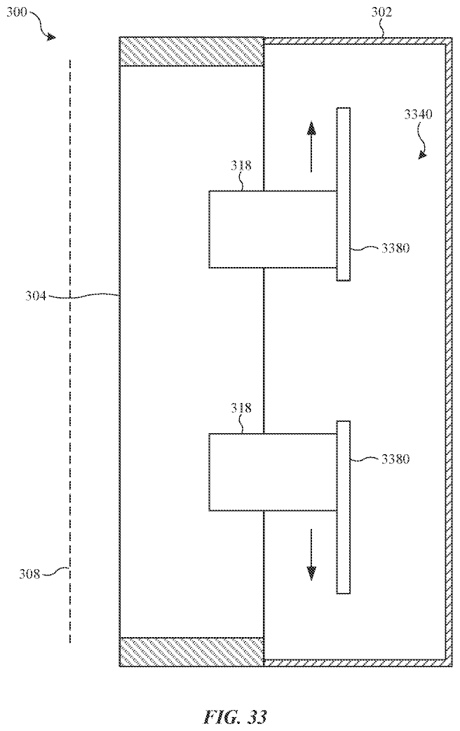

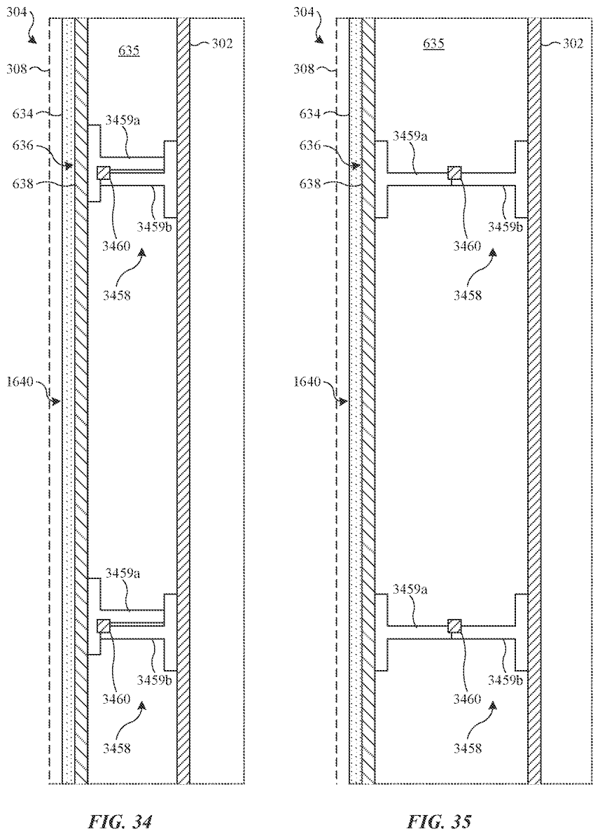

FIG. 34 is a top cross-section illustration of an impact mitigation structure 3440 that can be located inside the internal space 635 of the facial interface 304 of the head-mounted device 300 in a pre-deployment position and FIG. 35 is a top cross-section illustration of the impact mitigation structure 3440 in a deployed position. The impact mitigation structure 3440 is an implementation of the impact mitigation structure 340 and may be included in the head-mounted device 300 in place of the impact mitigation structure 340. The description of the head-mounted device 300 is applicable, and components described in connection with the impact mitigation structure 3440 are consistent with like-named parts from the head-mounted device 300 except as noted.

The impact mitigation structure 3440 includes two-piece deployable supports 3458. The two-piece deployable supports 3458 are configured to be deployed for an impact and space the support plate 638 from the device housing 302 to prevent contact by the face 108 with the device housing 302 or associated structures, such as the optical modules 318. The two-piece deployable supports 3458 deploy during an impact by pivoting into place between the device housing 302 and the internal support structure 636 (e.g., the support plate 638) to move the device housing 102 away from internal support structure 636 of the facial interface 304. This allows the facial interface 304 to space the device housing 302 and associated components (e.g., the optical modules 318) from the face 308 of the user.

In the illustrated implementation, the two-piece deployable supports 3458 include first support members 3459a, second support members 3459b, and actuators 3460. The support members 3459a, 3459b are structural components that, in the illustrated implementation, have a T-shaped configuration with portions extending along the front of the device housing 302 and along the facial interface 304. Portions of each of the support members 3459a, 3459b are nested and/or located in a side-by-side arrangement in a pre-deployment position (FIG. 34) and are moved to increase the distance between the device housing 302 and the internal support structure 636 in a deployed position (FIG. 35). The actuators 3460 cause the support members 3459 to move from the pre-deployment position to the deployed position in response to an impact detection (e.g., from the control electronics 211 as previously described with respect to the impact mitigation structure 1440). As one example, the actuators 3460 may be linear actuators configured to move the first support members outward relative to the second support members until axial end portions of the first support members 1359a engage axial end parts of the second support members 1359b (FIG. 35). This configuration spaces the device housing 302 and the internal support structure 636 and allows for deflection and or deformation of the support members 3459a, 3459b during an impact to absorb energy. As one example, the support members 3459a, 3459b may be spring biased to the deployed position and the actuators 3460 may be actuatable release mechanisms (e.g., mechanical catch that disengages by activation of a solenoid).

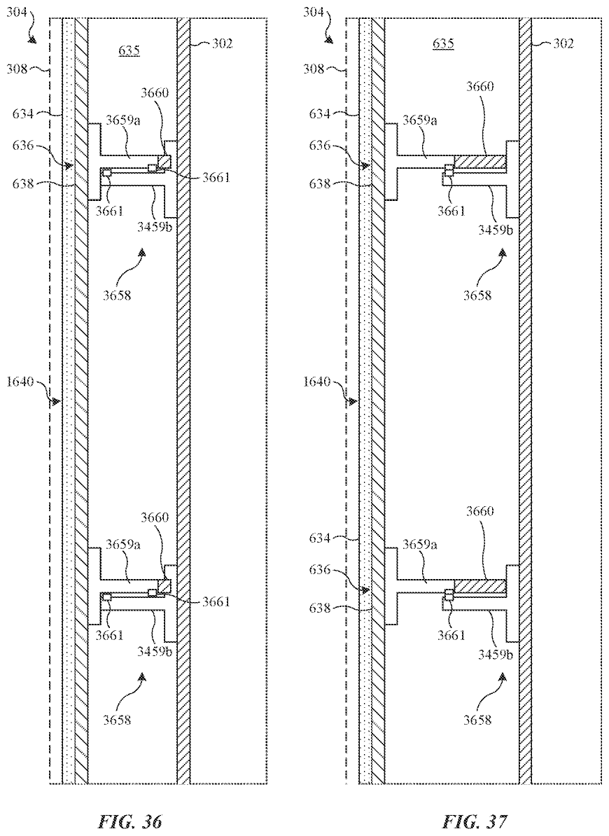

FIG. 36 is a top cross-section illustration of an impact mitigation structure 3640 that can be located inside the internal space 635 of the facial interface 304 of the head-mounted device 300 in a pre-deployment position and FIG. 37 is a top cross-section illustration of the impact mitigation structure 3640 in a deployed position. The impact mitigation structure 3640 is an implementation of the impact mitigation structure 360 and may be included in the head-mounted device 300 in place of the impact mitigation structure 360. The description of the head-mounted device 300 is applicable, and components described in connection with the impact mitigation structure 3640 are consistent with like-named parts from the head-mounted device 300 except as noted.

The impact mitigation structure 3640 includes two-piece deployable supports 3658. The two-piece deployable supports 3658 are configured to be deployed for an impact and space the support plate 638 from the device housing 302 to prevent contact by the face 108 with the device housing 302 or associated structures, such as the optical modules 318. The two-piece deployable supports 3658 deploy during an impact by pivoting into place between the device housing 302 and the internal support structure 636 (e.g., the support plate 638) to move the device housing 102 away from internal support structure 636 of the facial interface 304. This allows the facial interface 304 to space the device housing 302 and associated components (e.g., the optical modules 318) from the face 308 of the user.

In the illustrated implementation, the two-piece deployable supports 3658 include first support members 3659a, second support members 3659b, and actuators 3660. The support members 3659a, 3659b are structural components that, in the illustrated implementation, have a T-shaped configuration with portions extending along the front of the device housing 302 and along the facial interface 304. Portions of each of the support members 3659a, 3659b are nested and/or located in a side-by-side arrangement in a pre-deployment position (FIG. 36) and are moved to increase the distance between the device housing 302 and the internal support structure 636 in a deployed position (FIG. 37). The actuators 3660 cause the support members 3659 to move from the pre-deployment position to the deployed position in response to an impact detection (e.g., from the control electronics 211 as previously described with respect to the impact mitigation structure 1440). As one example, the actuators 3660 may be linear actuators configured to move the first support members outward relative to the second support members. To maintain the support members 3659a, 3659b in the deployed position and to allow the support members 3659a, 3659b to absorb energy during an impact, the support members 3659a, 3659b include interlock structures 3661, such as complementary engaging parts (e.g., a hook, a catch, an aperture, teeth, a pawl, etc.) that engage to restrain motion of the support members 3659a, 3659b from the deployed position toward the post deployment position. This configuration spaces the device housing 302 and the internal support structure 636 and allows for deflection and or deformation of the support members 3659a, 3659b during an impact to absorb energy. As one example, the support members 3659a, 3659b may be spring biased to the deployed position and the actuators 3660 may be actuatable release mechanisms (e.g., mechanical catch that disengages by activation of a solenoid).

As used in the claims, phrases in the form of “at least one of A, B, or C” should be interpreted to encompass only A, or only B, or only C, or any combination of A, B, and C.

As used herein, the terms computer-generated reality (CGR) experience and CGR content refers to a wholly or partially simulated environment that is accessed using an electronic device that allows the persons to interact with the wholly or partially simulated environment. The environment may be simulated in accordance with movements of the user and/or the device, such as by tracking a view angle and outputting content in correspondence with the view angle. A CGR environment may be a virtual reality (VR) environment in which simulated content is presented to the user while the user is isolated from the physical world, for example, by blocking visibility of the physical world. refers to a simulated environment that is designed to be based entirely on computer-generated sensory inputs for one or more senses. A CGR environment may be a mixed reality (MR) environment in which simulated content is presented to the user in combination with physical world, such as by layering the simulated content over a view of the physical world. Many different types of electronic devices can be used to experience a CGR environment.

Implementations of the disclosure may include gathering and storage of data for operation of the device, which may include personal information data that uniquely identifies or can be used to contact or locate a specific person. Usage of this information can benefit users and enhance the user's experience. It is contemplated that any use or handling of this information will comply with well-established privacy policies and/or privacy practices. Personal information should be collected for legitimate uses only, and only with consent from users. Security and privacy of the information must be upheld, including compliance with any applicable laws. It is further contemplated that use of this information is not mandatory for use of the device. The user may control whether such information is used to operate the device, and the device remains functional according to the description herein if the user does not wish to provide personal information.

What is claimed is:

1. A head-mounted device that is configured to be worn by a user, comprising:
a device housing;
a facial interface that is connected to the device housing;
a support structure that is configured to support the device housing with respect to the user so that the facial interface is in contact with a face of the user;
content display components that are located in the device housing and are configured to display content to the user; and
an impact mitigation structure that is configured to mitigate an impact with an external structure.

2. The head-mounted device of claim 1, wherein the impact mitigation structure includes a bump stop that is located inside the facial interface to disperse pressure from the impact.

3. The head-mounted device of claim 1, wherein the impact mitigation structure includes springs that are located inside the facial interface and extend between an internal support structure of the facial interface and the device housing to absorb energy during the impact.

4. The head-mounted device of claim 1, wherein the impact mitigation structure includes an air filled damper that is located inside the facial interface and extends between an internal support structure of the facial interface and the device housing to absorb energy during the impact.

5. The head-mounted device of claim 1, wherein the impact mitigation structure includes a non-Newtonian foam structure that is located inside the facial interface to absorb energy during the impact.

6. The head-mounted device of claim 1, wherein the impact mitigation structure includes an inflatable air bladder that is located inside the facial interface to absorb energy during the impact.

7. The head-mounted device of claim 1, wherein the impact mitigation structure includes deployable supports that deploy during the impact to move the device housing away from an internal support structure of the facial interface.

8. The head-mounted device of claim 1, wherein the content display components include an optical module, and the impact mitigation structure includes an energy absorbing material that is located on a portion of the device housing that surrounds an exposed portion of the optical module to absorb energy during the impact.

9. The head-mounted device of claim 1, wherein the impact mitigation structure includes a flexible rim that is located inside the facial interface, is stiffer than that the facial interface, and is connected to the device housing to absorb energy during the impact.

10. The head-mounted device of claim 1, wherein the impact mitigation structure includes dampers that are located in the support structure to regulate motion of the device housing relative to the face of the user during the impact.

11. The head-mounted device of claim 1, wherein the impact mitigation structure includes a resilient energy absorbing member that is located in the facial interface and is configured to absorb energy during the impact.

12. The head-mounted device of claim 1, wherein the impact mitigation structure includes a mounting structure that connects the facial interface to the device housing and causes the facial interface to detach from the device housing during the impact.

13. The head-mounted device of claim 1, wherein the impact mitigation structure includes a mounting structure that connects the facial interface to the device housing and allows the facial interface to slide laterally with respect to the device housing during the impact.

14. A head-mounted device that is configured to be worn by a user, comprising:
a device housing that defines an eye chamber;
control electronics that are configured to generate computer-generated reality content;
optical modules that are located partly in the eye chamber and are configured to display the computer-generated reality content to the user as part of a computer-generated reality experience;
a support structure that is configured to support the device housing with respect to the user;
a facial interface is configured to contact a face of the user; and
an energy absorbing structure that is located in the eye chamber of the device housing and is configured to control motion of the device housing during a dynamic loading event.

15. The head-mounted device of claim 14, wherein the energy absorbing structure includes an energy absorbing material that is located on a rear wall of the eye chamber adjacent to the optical modules.

16. The head-mounted device of claim 14, wherein the energy absorbing structure includes an inflatable air bladder that is located in the eye chamber adjacent to the optical modules and is inflated in response to the dynamic loading event.

17. The head-mounted device of claim 14, wherein the energy absorbing structure includes energy absorbing rings that are each connected to one of the optical modules.

18. A head-mounted device that is configured to be worn by a user, comprising:
a device housing that defines an eye chamber;
control electronics that are configured to generate computer-generated reality content;
optical modules that are located partly in the eye chamber and are configured to display the computer-generated reality content to the user as part of a computer-generated reality experience;
a support structure that is configured to support the device housing with respect to the user;
a facial interface is configured to contact a face of the user; and
an impact mitigation structure that allows motion of the optical modules with respect to the device housing during a dynamic loading event.

19. The head-mounted device of claim 18, wherein the impact mitigation structure is a crushable energy absorbing mounting structure that supports the optical modules with respect to the device housing.

20. The head-mounted device of claim 18, wherein the impact mitigation structure is a breakaway mounting structure that connects the optical modules to the device housing.

21. The head-mounted device of claim 18, wherein the impact mitigation structure is a mounting structure that connects the optical modules to the device housing so that the optical modules are able to pivot with respect to the device housing around a generally upright axis during the dynamic loading event.

22. The head-mounted device of claim 18, wherein the impact mitigation structure is a mounting structure that connects the optical modules to the device housing so that the optical modules are able to slide outward with respect to the user during the dynamic loading event.
